(19) United States
(12) Patent Application Publication
(10) Pub. No.: US 2025/0058388 A1
(43) Pub. Date: Feb. 20, 2025

(54) Jigsaw Comprising Mutually Spaced Connecting Regions

(71) Applicant: Robert Bosch GmbH, Stuttgart (DE)

(72) Inventors: Michael Sperl, Stuttgart (DE); Thorsten Kuehn, Eislingen (DE)

(21) Appl. No.: 18/725,347

(22) PCT Filed: Dec. 20, 2022
(86) PCT No.: PCT/EP2022/086962

§ 371 Date: Jun. 28, 2024

(30) Foreign Application Priority Data
Dec. 30, 2021 (DE) 10 2021 215 108.6
Dec. 30, 2021 (DE) 10 2021 215 130.2

(51) Int. Cl. B23D 49/16; B25F 5/00

(52) U.S. Cl. CPC B23D 49/162; B23D 59/0064; B25F 5/006

(57) ABSTRACT

The disclosure relates to a jigsaw having a housing unit and a base plate, wherein the housing unit is at least 25%, in particular around 40-60%, longer than the base plate in the longitudinal direction of the jigsaw. According to the disclosure, the housing unit and the base plate are bracingly interconnected, in particular in a rigid or damped manner, by means of two connecting regions, which are mutually spaced in the longitudinal direction of the jigsaw, in particular comprising bearing and/or fixing points.

The invention relates to a jigsaw having mutually spaced connecting regions between the housing unit and the base plate.

### PRIOR ART

Jigsaws according to the preamble of claim 1 are already known.

### DISCLOSURE OF THE INVENTION

The invention relates to a jigsaw having the features of claim 1. Advantageous further embodiments can be found in the dependent claims.

### Mutually Spaced Connecting Regions

A jigsaw having a housing unit and a base plate is proposed, wherein the housing unit is longer in the longitudinal direction of the jigsaw than the base plate, in particular at least 25%, advantageously around 40-60% longer than the base plate. It is proposed that the housing unit and the base plate are interconnected by means of two connecting regions mutually spaced in the longitudinal direction of the jigsaw, in particular comprising bearing and/or fixing points, in particular in a rigid or damped manner, in particular bracingly interconnected. This can increase the stability of the jigsaw. Good maneuverability of the jigsaw can be achieved. Good visibility of a workpiece to be processed, particularly in the rear region of the base plate, is maintained despite the second connecting region.

It is proposed that the base plate, the housing unit and the mutually spaced connecting regions advantageously delimit an opening, in particular a reach-through opening. The opening or reach-through opening provides space for fingers of a hand of a user of the jigsaw when gripping or working with it. The housing unit advantageously comprises a motor housing section and a hoist housing section. For example, when gripping the housing unit, in particular the motor housing section of the housing unit and/or a bar handle of the jigsaw, the fingers of the hand end up resting in the reach-through opening. This prevents them from touching the workpiece. This makes it possible to safely grasp, grip and/or guide the jigsaw. Reverse sawing, i.e. sawing a workpiece with the saw blade pointing upwards, for example, to reduce chip breakage on a visible surface of the workpiece, is also more convenient. The thumb can rest in the reach-through opening. The opening can also increase the visibility of the workpiece. In addition, control elements or the like can be actuated through the opening or from the opening, for example.

It is proposed that the connecting regions have a distance of at least 25% of the length of the base plate, advantageously 25-75% of the length of the base plate and/or a distance of at least 25% of the longitudinal extension of the jigsaw, advantageously 30-50% of the longitudinal extension of the jigsaw. This ensures that the housing unit is securely mounted. The load on the intermediate housing of the housing unit remains low. An advantageous distribution of contact pressure from the handle to the base plate can be ensured. Housing wall thicknesses can be sensibly dimensioned. Good force distribution is ensured. At this distance, there is sometimes enough space for several fingers or a large hand of the user in the opening or reach-through opening. It is sometimes possible to ensure sufficient visibility through the opening. Force transmission from the rear region of the jigsaw, for example from a battery, can be advantageous, even if the jigsaw falls, for example.

It is proposed that a center of gravity of the jigsaw, advantageously with or without a battery applied to the jigsaw, is positioned within the opening or reach-through opening or between the opening and the longitudinal axis. The center of gravity is therefore as close as possible to the base plate and/or as close as possible to the saw blade. This is good for a secure stand of the jigsaw and/or maneuverability. In particular, this makes it difficult for the jigsaw to tip over. Apart from the contact force, the user does not have to absorb much torque when sawing or apply it with their hand, for example, when inverting. In particular, a center of gravity does not protrude from the rear of the base plate in the longitudinal axis direction, which advantageously enables the jigsaw to stand securely on the base plate, sometimes regardless of the capacity of the battery, corresponding to a high or rather low weight of the battery.

It is proposed that the first connecting region is arranged adjacent to a front-side sawing or chipping region of the jigsaw, and the second connecting region is arranged adjacent to a rear-side battery interface region of the jigsaw and/or adjacent to a rear region of the motor housing section of the housing unit. Contact forces on the housing unit, in particular introduced via a pole-shaped handle or a bow handle and/or falling forces that have to be transferred between the battery and the base plate, for example, can be ideally transferred from the housing unit to the base plate. Overall, user-friendliness can be improved, visibility of the workpiece to be sawn can be increased, and/or forces can be easily redirected or dissipated.

It is proposed that the first connecting region is arranged in the region of a gearbox flange or bearing flange or supporting frame of the hoist gear of the jigsaw connected to the base plate and/or the second connecting region is advantageously arranged below an advantageously t, in particular substantially squarely thicker end region of the motor housing section of the jigsaw. Forces that are introduced via the handle or handles, in particular the bar handle and/or knob handle or the bow handle, or the motor housing or hoist housing can thus be transmitted to the base plate or foot plate or base plate unit in a safe and/or balanced manner. Advantageously, the housing unit is connected via the gearbox flange or bearing flange or support frame in the first connecting region so that, for example, contact pressure forces or holding forces can be transmitted as perpendicularly as possible to the base plate in this region. The square thickening can sometimes also intuitively separate the bar handle from the thicker region, as the thicker region is not so easy to grip. The thickened region sometimes reinforces the housing unit, especially in the region where a battery and/or the bow handle is connected. A contact surface for a support element or the second connecting region can be increased as a result. A force, in particular on the housing unit, may be distributed homogeneously. In particular, forces from the battery interface, be it when setting up the jigsaw on the battery, changing the battery or the exchangeable rechargeable battery pack, can be transmitted well to the second connecting region or the base plate, in particular, with force or speed and/or forces when the jigsaw falls.

It is proposed that the connecting regions, in particular parting joints of the connecting regions, have a vertical offset and/or a horizontal offset to each other, in particular a vertical offset of 15-20 mm, in particular around 18 mm and/or a horizontal offset of 95-105 mm, in particular around 100 mm. As a result, an opening or the reach-through opening can be advantageously enlarged, particularly in its height perpendicular to the workpiece contact surface. For example, the first connecting region can be arranged very close to the base plate, for example the second connecting region very close to the battery interface, in particular without the battery interface having to be arranged close to the workpiece contact surface and/or, for example, space being provided for dust extraction, for example via an suction nozzle in the rear region of the base plate. The housing unit, in particular the motor housing section of the housing unit, can thus be guided slenderly to the rear. This can have advantages for the inverse cut, as space is created for the forearm and/or even a contact surface of the forearm in the connecting region and/or in the region of a support element, for example.

It is proposed that a connecting surface delimited at least by the housing unit in the connecting plane or parting joint plane of the first connecting region and second connecting region is around 20-40%, advantageously around 30%, of the connecting surface delimited by the foot plate in the workpiece contact plane and/or that a connecting surface delimited at least by the housing unit in the connecting plane or parting joint plane of the first connecting region is larger than the connecting surface in the connecting plane or parting joint plane of the second connecting region, in particular around 20-60% larger, advantageously around 40% larger. This means that the view of the workpiece is only slightly obstructed by the housing unit. In addition, the space between the housing unit and the base plate or base plate unit offers sufficient space for fingers, especially in the reach-through opening. Overall, less material can be required for the connection between the housing unit and the base plate unit. Nevertheless, the housing unit protects safety-relevant regions—in particular the sawing and machining region—from access.

It is proposed that a connecting surface delimited at least by the housing unit, in particular a connecting surface delimited from three sides or substantially U-shaped, in the connecting plane or parting joint plane of the first connecting region is around 15-25%, advantageously around 18%, of the connecting surface delimited by the foot plate in the workpiece contact plane and/or that, a connecting surface delimited at least by the housing unit, in particular a connecting surface delimited by four sides or substantially square or rectangular, in the connecting plane or parting joint plane of the second connecting region is around 10-15%, advantageously around 13%, of the connecting surface delimited by the foot plate in the workpiece contact plane. This means that the view of the workpiece is only slightly obstructed by the housing unit. Overall, the connecting surfaces are small in relation to the workpiece contact surface delimited by the foot plate, but a stable connection between the housing unit and the base plate unit can still be provided by mutually spacing them.

### Support Element

In connection with the aforementioned or independently thereof, a jigsaw is proposed, having a housing unit and a base plate unit, in particular comprising a base plate, advantageously comprising a base plate and a foot plate or sliding plate, wherein the housing unit and the base plate are connected, in particular by means of two connecting regions designed to be mutually spaced.

It is proposed that the base plate or base plate unit and the housing unit are connected via a support element, in particular a support element formed integrally with the base plate, wherein the support element extends at an acute angle, arcuate and/or offset to a workpiece contact surface of the base plate unit. The angled or arcuate alignment creates space for the reach-through opening between the housing unit and the base plate. Supporting forces can be easily transferred to the base plate or housing unit. The offset embodiment allows integrated support surfaces to be formed advantageously. The reach-through opening is also as large as possible. The components involved can be relatively slim in size. The amount of material used is advantageously low, as is the weight. As a result of the one-piece design, the connection can be very rigid. A transition between the base plate and the support element can be very homogeneous, particularly in a region where a lower arm is advantageously in contact with the inverse cut.

It is proposed that the housing unit and the base plate are connected via a support element, in particular an exposed support element, in particular a support element exposed in the region of a support leg, advantageously comprising a support end and/or a support surface, which advantageously forms the second connecting region to the housing unit. This can improve visibility onto the workpiece and/or into the reach-through opening. The support element can serve as a contact surface for fingers and/or a forearm (inverse cut). This keeps the jigsaw light. A housing does not have to be thickened up to the base plate. Despite the support element, there is space for a dust nozzle to be detachably connected to the base plate. The weight of the jigsaw remains relatively low.

It is proposed that the support element is a load-bearing, rigid element and/or is formed integrally with the base plate, in particular having, advantageously made of metal, for example an aluminum alloy. This keeps the jigsaw light yet stable. As a result of the one-piece design, the connection can be very rigid. A transition between the base plate and the support element can be very homogeneous, particularly in a region where a lower arm is advantageously in contact with the inverse cut. The support element can transfer forces well and stably both from the base plate to the housing unit and from the housing unit to the base plate.

It is proposed that the support element, in particular a support leg of the support element, forms, in relation to the base plate and/or the housing unit, an offset shape, an oblique shape relative to the base plate and/or an arcuate shape. The angled or arcuate alignment creates space for the reach-through opening between the housing unit and the base plate. Supporting forces can be easily transferred to the base plate or housing unit. The offset embodiment allows integrated support surfaces to be formed advantageously. The reach-through opening can also be designed to be as large as possible. The components involved can be relatively slim in size. The amount of material used is advantageously low, as is the weight.

It is proposed that the support element forms a support surface for the housing unit parallel to the workpiece contact surface of the base plate and/or foot plate, in particular also formed by the support end, advantageously having an axial and vertical offset workpiece contact surface base plate, in particular connected to the base plate by at least one oblique, offset or arcuate support leg or support arm. This prevents the housing unit from being overloaded. The housing unit can remain aligned parallel to the workpiece contact surface or longitudinal axis. The fact that the support end also forms a support surface means that forces can be transmitted in both vertical and horizontal directions in a two-dimensional and/or positive-locking manner. A frictional locking can also be created using additional connecting means, such as a screw connection. Overall, forces can be transmitted homogeneously between the housing unit and the support element or the base plate. Due to the axial and vertical offset, the second connecting region can be positioned close to the rear region of the housing unit, despite the short base plate compared to the length of the jigsaw.

It is proposed that the connection of the support element to the base plate and the support element to the housing unit have a horizontal offset, and advantageously also a vertical offset. Forces from the battery interface and/or the housing unit can thus be safely transferred to the base plate unit in the rear region.

It is proposed that the support leg forms an angle of 30-60°, preferably around 40-50°, with the workpiece contact surface of the base plate and/or foot plate and/or a support surface of the support element for the housing unit. As a result, a lower arm can advantageously rest against the support element as orthogonally as possible in an angle range of 60-120° during a typical inverse cut. An actuating element in the support element can thus be easily visible and/or actuated. This can be advantageous for fingers accommodated in the reach-through opening in terms of support on the support element.

It is proposed that the support element and the housing unit have corresponding positive-locking geometries, in particular providing support in at least two spatial directions extending perpendicularly or obliquely to each other, in particular perpendicular or oblique to the longitudinal axis direction and in the hoist axis direction of the jigsaw, in particular on the part of the housing unit a battery interface providing support to battery interface. Forces can be transmitted in both vertical and horizontal directions with a positive fit. This means that forces do not have to be transmitted exclusively via a frictional locking. It can also make the housing unit and/or battery interface more rigid.

It is proposed that the housing unit or the motor housing in the second connecting region has a larger circumference around the longitudinal axis and/or is designed to be thicker, in particular is designed to be substantially square or rectangularly thicker, in particular with respect to a housing region or motor housing region surrounding the drive unit. The thickening advantageously and intuitively delimits the connecting region from the handle region. The thickened region sometimes reinforces the housing unit, in particular in the connecting region and/or in the region of a connection to a battery and/or the bow handle. A contact surface for a support element or the second connecting region can be increased. A force, in particular on the housing unit, may be distributed homogeneously.

It is proposed that the support element is designed such that it tapers from the base plate towards the housing unit, in particular tapers concavely, in particular having a decreasing width. The tapering, in particular the concave tapering, improves comfort during inverse sawing. The wrist does not have to be angled relative to the forearm during the inverse cut. Instead, the back of the hand and the outer surface of the forearm can remain as straight as possible relative to each other or in the same plane during operation. This increases comfort, but sometimes also precision. Visibility can be increased. The concave shape, which resembles an oval forearm, also offers a pleasant tactile support. This can increase visibility of the region behind the base plate. The risk of collision with objects, for example when sawing in narrow regions and/or when cutting curves, can be reduced.

It is proposed that the support element protrudes axially beyond the base plate, in particular on a side of the base plate facing away from the sawing region. The base plate is advantageously designed to be substantially flush with the front end of the jigsaw or the front region of the jigsaw. The base plate can therefore be short, which has a positive effect on the maneuverability of the jigsaw and/or the visibility of the workpiece. The support element stands out from the workpiece contact surface of the base plate unit. Because it protrudes axially beyond the base plate, it protrudes advantageously into the rear region of the jigsaw, in particular the region of the battery interface or end region of the motor housing. It can therefore direct and/or support forces from this region to the base plate.

It is proposed that a damping element is arranged in the connecting region, in particular between the housing unit and the support element. This can improve vibration and/or sound transmission. In particular, this can increase safety for the user, for example through lower vibration values at the handle.

It is proposed that the support element accommodates a locking mechanism, in particular an operating and/or latching element, in particular at least one fixing element, advantageously a prestressed latching element, for releasably fixing a dust nozzle adapter. This results in functional integration. Furthermore, this can be conveniently reached through the opening or reach-through opening. It offers advantageous space for moving the fixing element, in particular swiveling.

The ergonomics of the jigsaw can be improved. The reach-through opening allows the jigsaw to be gripped close to the point where the jigsaw blade plunges into the workpiece. The opening allows you to securely grip and/or encompass the jigsaw handle. The thumb and/or index finger can easily operate the on/off switch. Control elements are advantageously provided on both sides of the separation plane, on the housing unit, in particular in the hoist housing section. These are slightly offset to the outside by a thickening. A finger recess is advantageously formed in the vertical or hoist axis direction between the thickening and the hoist housing above it. This can advantageously serve as an additional contact surface for fingers of the user's hand when gripping the knob handle and/or gripping the bar handle, in particular for the outer surface of the hand in the region of the little finger or the outer surface of the little finger itself. It also serves as an contact surface for the index finger and thumb of the guide hand. In particular, unintentional switching off of the machine tool can be made more difficult, as the in/out grip is offset by the finger recess. Due to the thickened or widened and/or modified shape (more square/rectangular than oval/around) of the housing unit, especially in the second connecting region, accidental actuation of the functional interface is also avoided, as this region is clearly separated from the handle, in particular the bar handle. Due to the relatively short first connecting region in the longitudinal axis direction between the housing unit and the base plate or base plate unit, which can also be short in particular due to the second connecting region, the handle comes to rest close to the saw blade or the hoist axis in relation to the longitudinal axis. The bar handle can therefore be long enough to provide sufficient space for a large user hand, for example, in particular without the functional interface being accidentally actuated.

It is proposed that an upper and lower gripping surface of the pole-shaped handle at an end of the pole-shaped handle facing the saw blade or in the transition region to the hoist housing section end substantially in a common plane that runs normal to the longitudinal axis. This allows the handle to be gripped in an ergonomically advantageous manner. The hand can be positioned close to the hoist axis. The sawing result can be improved, in particular through increased maneuverability and/or directness of the guide.

It is proposed that a distance between the battery interface and the second connecting region of the base plate is less than 50 mm, advantageously less than 25 mm. This allows the battery interface to be advantageously supported by the second connecting region. This is advantageous for changing the battery pack, if the jigsaw is dropped or similar. Sometimes it can also extend the service life of the jigsaw.

It is proposed that a distance between the saw blade and the reach-through opening enclosed by the base plate and the handle is less than 60 mm, in particular 50 mm. This improves the guiding behavior. The pivot point of the hand is thus close to the hoist axis, which improves the guiding properties of the jigsaw.

### Suction Dust Nozzle

In connection with the aforementioned or independently thereof, a jigsaw comprising a base plate unit with a suction unit is proposed, wherein the suction unit has at least one suction nozzle holder, in particular a suction nozzle holder arranged in the base plate unit, which is designed for detachable connection to a suction nozzle. It is proposed that the jigsaw, in particular the base plate unit of the jigsaw, has a movable, in particular pivotably mounted fastening element for a positive-locking fixation of the suction nozzle. This makes it easy to connect and disconnect the suction nozzle. In particular, pulling off a suction hose, for example by pulling and turning an elastic frictional locking, can be avoided. A secure and/or simple connection of the suction nozzle to the suction nozzle holder can be achieved despite the sometimes confined space conditions.

It is proposed that the fastening element is pivotably arranged on the base plate unit and/or a support element for providing support for a housing unit of the jigsaw relative to a base plate of the base plate unit, advantageously a support element which is arranged at a distance from a first connecting region between the base plate and the housing unit, in particular at a distance from a connecting or support region of the base plate and housing unit arranged adjacent to the sawing region. The pivotable arrangement enables intuitive operation. A visual inspection of the connection can be carried out easily. Spring pre-tensioning of the fastening element can be achieved in a space-saving manner. The arrangement in the support element enables functional integration. This region is sometimes very easy and/or possible without having to encompass the operator's hand on the handle.

It is proposed that the support element is offset or curved starting from a base plate of the base plate unit, in particular wherein the fastening element is arranged in an oblique or arcuate surface, in particular surface, between the base plate and the housing unit of the jigsaw, advantageously flush with the surface of the support element, advantageously flush with the surface on the side of the support element facing the housing unit. This can advantageously also provide good support for the housing unit and base plate unit relative to each other. In particular, this allows the support element to be spaced apart from the workpiece contact surface, in particular to form a stable connecting surface to the housing unit that is provided at a distance from the workpiece contact surface by the support element. Advantageously, the support element can be concave or convex, curved. In particular, it can advantageously taper in width. In particular, it is formed integrally with the base plate.

It is proposed that the fastening element is pivotably mounted in a recess, in particular a recess of the support element, in particular recessed in the base plate unit and/or the support element, advantageously flush with the surface. This prevents accidental release. In particular, a handle region of the fastening element can be clearly demarcated. Contamination of the swivel mechanism can be avoided, in particular jamming due to sawdust or the like.

It is proposed that the base plate unit, advantageously the support element, completely surrounds the fastening element in a circumferential direction, in particular in a pivot axis plane of the fastening element—i.e. a plane in which the pivot axis of the fastening element is positioned—in particular it is surrounded by the recess in the support element. This allows the fastening element to be protected from damage. In particular, it is made of plastic. The functional integration can thus be further improved.

It is proposed that pivot bearings of the fastening element are each accommodated in one support leg or one support strut of the support element, in particular in a support element divided in two by the recess for the fastening element, and/or the support element has two support legs or support struts, the support legs are designed with mirror-like symmetry to the center parting plane of the jigsaw or to the center parting plane, in particular accommodating the fastening element between them. This means that the fastening element can be reached equally well by left-handed or right-handed people, or from both sides. Damage to the fastening element can be avoided. Forces, in particular transverse forces acting on the housing or base plate unit, can be transmitted well via the support element. The stability can be increased.

It is proposed that the fastening element is spring-loaded, advantageously pivotally supported against the base plate unit, in particular pivotally supported against the support element. This allows the fastening element to be automatically moved to an initial position and/or latching position. Automatic latching with a suction nozzle when inserting into the suction nozzle holder can be enabled.

It is proposed that the fastening element and/or the suction nozzle are designed in such a way, in particular having corresponding latching and/or counter-latching means, for example by means of guide and/or sliding surfaces, that the fastening element automatically swivels out of a latching position when the suction nozzle is inserted into the suction nozzle holder. In particular, wherein the fastening element swivels back into the latching position when the suction nozzle is fully inserted into the suction nozzle holder in order to form a positive-locking connection with the corresponding latching means on the suction nozzle. This can increase ease of use. An suction nozzle can be intuitively connected to or disconnected from the jigsaw.

It is proposed that a handle element of the fastening element is arranged on a side of the base plate unit or the support element facing a housing unit of the jigsaw, in particular a side facing the reach-through opening, in particular projecting substantially orthogonally beyond the fastening element, which is otherwise flush with the surface of the support element, advantageously pivotally limited by a positive-locking fit between the base plate unit or support element and the fastening element. This allows the handle element or fastening element to be easily reached. Intuitive operation can be made possible. Accidental operation can be avoided. Good accessibility from the reach-through opening can be enabled.

In connection with the aforementioned or independently thereof, a jigsaw with a base plate unit, a housing unit and a suction unit is proposed, wherein the suction unit has at least one suction nozzle holder which is designed for detachable connection to a suction nozzle, wherein the base plate unit is connected to the housing unit of the jigsaw by means of a support element providing support. It is proposed that the support element has a fastening element for fixing the suction nozzle, in particular a movable, advantageously a pivotable, preferably a pivotably mounted fastening element, advantageously for a positive-locking fixation of the suction nozzle to, in particular in, the suction nozzle holder. This makes it possible to achieve functional integration of a fastening element in a jigsaw with a support element, in particular having two mutually spaced connecting regions.

An suction nozzle for an aforementioned jigsaw is proposed, having at least one positive-locking element, in particular a counter-locking means for fixing by the movably mounted fastening element.

### Pendulum Hoist Adjuster

In connection with the aforementioned or independently thereof, a jigsaw having a housing unit, a base plate unit and a gear frame or bearing flange for a hoist gear and/or drive train of the jigsaw is proposed, wherein a pendulum hoist adjuster, in particular a pendulum hoist swivel handle, is pivotably and swingingly mounted on the gear frame or bearing flange. It is proposed that the pendulum hoist adjuster is enclosed by the housing unit axially along its pivot axis, on the side facing away from the gear frame or bearing flange. This allows the pendulum hoist adjuster or the pendulum hoist swivel handle to be integrated into the housing unit. This can protect it. Sawing close to the wall can be made possible. Sometimes the housing can also be gripped in the region of the pendulum hoist adjuster, which can result in greater flexibility when gripping the jigsaw. Advantageously, the pendulum hoist swivel handle, in particular a central region, is enclosed by the housing unit in the circumferential direction, in particular enclosed about a longitudinal axis of the pendulum hoist swivel handle orthogonal to the pivot axis of the pendulum hoist adjuster. The pendulum hoist adjuster is advantageously connected in a non-rotatable manner to a pivot pin via a mount. In particular via a positive-locking connection, for example a plug-in connection. In particular, this can be axially movable and non-rotatable in the circumferential direction around the pivot pin. Overhung bearings are not to be understood as being axially mounted on both sides of the pendulum hoist adjuster mounted on the axis of rotation, but only on one side of the axis of rotation. The pendulum hoist adjuster, or pendulum hoist swivel handle, is typically indirectly connected to an already known pendulum hoist adjusting and/or generating mechanism to enable a pendulum movement of a pendulum roller lever typically in different stages. For example, five steps can be provided, e.g. causing the saw blade of the jigsaw to oscillate between 0-2°. The pendulum hoist adjuster or the pendulum hoist swivel handle can be moved, for example, from a 0 position for no pendulum hoist, through three middle positions, to a maximum position for a maximum pendulum hoist of, for example, 2° pivoting motion of the saw blade. As an example, it is pivoted by a total of approx. 70-90°.

It is proposed that the housing unit forms an anti-loss device for the pendulum hoist adjuster, in particular the pendulum hoist swivel handle, in particular to prevent the pendulum hoist adjuster from slipping along the pivot axis, advantageously without further securing means such as circlips or screws, in particular by means of an internal housing wall of the housing unit, so to speak as a stopper surface. This allows the housing wall to be kept slim. A thickening, for example for a bearing point, is not required. Additional securing means can be avoided so that, for example, the pivot pin for the pendulum hoist adjuster can be short and/or does not protrude axially beyond the pendulum hoist adjuster. Functional integration can take place.

It is proposed that the pendulum hoist adjuster, in particular the pendulum hoist swivel handle, is arranged in projection along a hoist axis of the jigsaw, at least substantially, advantageously completely within the projection surface of the housing unit. So to speak, in vertical projection, or projection perpendicular to the workpiece contact surface of the base plate unit. This advantageously enables sawing close to the wall, in particular as the pendulum hoist adjuster or the pendulum hoist swivel handle does not bear laterally. The pendulum hoist adjuster or the pendulum hoist swivel handle can be protected. In particular, it remains protected by the housing unit during transportation, work or if the jigsaw falls. The pendulum hoist swivel handle can be made easily accessible.

It is proposed that the base plate unit is connected to the housing unit and/or to the gear frame or bearing flange in a connecting region, in particular a first of two connecting regions, and that at least a part of the pendulum hoist adjuster or the pendulum hoist swivel handle, in particular the region surrounding the pivot axis, in particular a part arranged within the housing unit, is positioned within the projection surface of the connecting region in projection along a hoist axis of the jigsaw. This allows functional integration to be provided. The connecting region can be very narrow in relation to a separation plane of the jigsaw, in particular between the saw blade and a reach-through opening. The pendulum hoist adjuster or the pendulum hoist swivel handle can be operated intuitively and easily when gripping the jigsaw. At least a part of the pendulum hoist adjuster or the pendulum hoist swivel handle can advantageously be arranged opposite a workpiece contact surface of the base plate unit, in particular arranged directly above a connecting region, in particular a first connecting region between the base plate unit or base plate and the housing unit.

It is proposed that the pendulum hoist adjuster or the pendulum hoist swivel handle, in particular a handle end of the pendulum hoist adjuster or the pendulum hoist swivel handle, is arranged at least partially in the region of a reach-through opening and/or between two mutually spaced connecting regions, the base plate unit and the housing unit. Advantageously, this enables protected and/or good accessibility of the pendulum hoist adjuster or the pendulum hoist swivel handle.

It is proposed that the pendulum hoist adjuster is arranged relative to a sawing or parting plane of the jigsaw opposite a blowing function adjuster, in particular a blowing function adjusting swivel handle. This can save installation space. The compactness of the saw can be increased. Intuitive operation of the jigsaw and its additional functions can be improved. A clear spatial separation can prevent operating errors, for example by confusing the functions. The ergonomics of the jigsaw can be improved. The sawing or parting plane is spanned by the hoist axis and the motor axis, or the longitudinal axis of the jigsaw.

It is proposed that an blow-out opening for blow-off air not directed to the sawing or chipping region, in particular blow-off air generated by a fan impeller, is arranged in the connecting region, in particular in the first connecting region of two mutually spaced connecting regions, between the base plate unit and the housing unit and/or a projection surface of the pendulum hoist adjuster or the pendulum hoist swivel handle and the blow-out opening are superimposed in projection along a hoist axis of the jigsaw. The arrangement in the connecting region results in functional integration. Installation space and/or components, for example bearing components, can be saved. Assembly can be simplified. An air guide element, in particular an air guide flap, can be positioned very close to the sawing or chipping region, at least in the hoist axis direction. Blow-off air or cooling air can be redirected with low flow loss, which sometimes saves energy (low air resistance at the fan impeller). Exhaust air can advantageously be directed into a region, preferably between 0 and 90° to the separation plane, in particular around 45° to the separation plane in the rear direction of the jigsaw. This means that the user is disturbed less.

### Blowing Function Adjuster

In connection with the aforementioned or independently thereof, a jigsaw having a housing unit and a base plate unit is proposed, having a blowing function adjuster, in particular a blowing function adjusting swivel handle, for selectively setting a blowing function of the jigsaw, advantageously by deflecting a cooling air, in particular motor cooling air, into a sawing or chipping region of the jigsaw or to an blow-out opening. It is proposed that the blowing function adjuster or the blowing function adjustment swivel handle is pivotably mounted in the base plate unit and/or in a connecting region between the base plate unit and the housing unit. In particular, the blowing function adjuster or the blowing function adjustment swivel handle is pivotably mounted in the base plate unit and is also mounted by the housing unit of the jigsaw. In particular, it is mounted in a parting joint of the connecting region and/or adjacent thereto. In particular, the base plate unit encloses the pivot axis of the blowing function adjuster, in particular a blowing function adjusting swivel handle, from three sides and the housing unit from the fourth, so that the pivot axis is enclosed by them on all sides in the circumferential direction. Installation space can be saved. Function integration takes place. The blowing function adjuster, in particular a blowing function adjusting swivel handle, can be protected. Sawing close to the wall can be made possible. The blowing function adjuster or the blowing function adjusting swivel handle can, for example, be moved from a 0 position—for no blowing into the sawing or chipping region, but deflection to a blow-out opening—to a blowing position into the sawing or chipping region. For example, it is pivoted by approx. 60-90°. In particular, latching means are provided so that the blowing function adjuster or the blowing function adjusting swivel handle intuitively remains in the two positions.

It is proposed that the blowing function adjuster, in particular the blowing function adjusting swivel handle in projection along a hoist axis of the jigsaw, is arranged at least substantially, advantageously completely, within the projection surface of the housing unit. So to speak, in vertical projection, or projection perpendicular to the workpiece contact surface of the base plate unit. This is advantageous for sawing close to the wall, especially as the blowing function adjuster or the blowing function adjusting swivel handle does not rest on the side. The blowing function adjuster or the blowing function adjusting swivel handle can be protected. In particular, it remains protected by the housing unit during transportation, work or if the jigsaw falls. The blowing function adjusting swivel handle can be made easily accessible.

It is proposed that the base plate unit is connected to the housing unit and/or to the gear frame or bearing flange in a connecting region, in particular a first of two connecting regions, and that at least a part of the blowing function adjuster or the blowing function adjusting swivel handle, in particular a part arranged within the housing unit, is positioned within the projection surface of the connecting region in projection along a hoist axis of the jigsaw. This allows functional integration to be provided. The connecting region can be very narrow in relation to a separation plane of the jigsaw, in particular between the saw blade and a reach-through opening.

It is proposed that the blowing function adjuster or the blowing function adjusting swivel handle, in particular a handle end of the blowing function adjuster or the blowing function adjusting swivel handle, is arranged at least partially in the region of a reach-through opening and/or between two mutually spaced connecting regions, the base plate unit and the housing unit. Advantageously, this enables protected and/or easy accessibility of the blowing function adjuster or the blowing function adjusting swivel handle.

It is proposed that the blowing function adjuster is arranged relative to a sawing or parting plane of the jigsaw opposite a pendulum hoist adjuster, in particular a pendulum hoist swivel handle. This can save installation space. The compactness of the saw can be increased. Intuitive operation of the jigsaw and its additional functions can be improved. A clear spatial separation can prevent operating errors, for example by confusing the functions. The ergonomics of the jigsaw can be improved. The sawing or parting plane is spanned by the hoist axis and the motor axis, or the longitudinal axis of the jigsaw.

It is proposed that a blow-out opening for blow-off air that is not directed to the sawing or chipping region, in particular blow-off air generated by a fan impeller, is arranged in the connecting region between the base plate unit and the housing unit and/or a projection surface of the pendulum hoist adjuster or the pendulum hoist swivel handle and a blow-out opening are superimposed on each other, in projection along a hoist axis of the jigsaw, are superimposed and/or the blow-out opening is arranged relative to a sawing or parting plane of the jigsaw opposite the blowing function adjuster, in particular the blowing function adjusting swivel handle. The arrangement in the connecting region results in functional integration. Installation space and/or components, for example bearing components, can be saved. Assembly can be simplified. An air guide element, in particular an air guide flap, can be positioned very close to the sawing or chipping region, at least in the hoist axis direction. Blow-off air or cooling air can be redirected with low flow loss, which sometimes saves energy (low air resistance at the fan impeller). Exhaust air can advantageously be directed into a region, preferably between 0 and 90° to the separation plane, in particular around 45° to the separation plane in the rear direction of the jigsaw. This means that the user is disturbed less.

### Pliers Guide Unit

In connection with the aforementioned or independently thereof, a jigsaw having a housing unit and a base plate unit is proposed, comprising at least one base plate, wherein a pliers guide unit is accommodated on the jigsaw, in particular the base plate unit, comprising at least one pliers guide and an adjuster, in particular an adjusting screw, wherein the pliers guide unit is provided for adjusting a transverse play of a saw blade which can be inserted into a tool holder of the jigsaw, wherein the base plate unit has a tool center opening, in particular a through hole through the base plate, advantageously for enabling access to the adjusting means. The adjusting means, in particular the adjusting screw, is provided for adjusting the distance between the guide jaws of the pliers guide unit. The tool center opening advantageously extends from outside the sawing or chipping region and/or one side of the base plate unit, through the base plate unit or the base plate to the sawing or chipping region of the base plate unit. The tool center opening enables access to the adjuster of the pliers guide unit by means of a tool, in particular by means of a hexagon wrench, advantageously guided access.

It is proposed that a longitudinal axis of the tool center opening is substantially parallel to the workpiece contact surface of the base plate unit or the base plate or foot plate, in particular having a distance of less than 20 mm, advantageously less than 15 mm, in particular having around 13.5 mm. This allows the pliers guide unit to be positioned very close to the workpiece contact surface. In addition, it is possible to adjust the pliers guide unit when the jigsaw is positioned on the workpiece contact surface. Advantageously, the setting element is visible when the jigsaw is in a lateral position.

It is proposed that a longitudinal axis of the tool center opening is formed transversely, in particular perpendicular to a cutting or sawing plane of the jigsaw, in particular a cutting or sawing plane of the jigsaw which is clamped by a longitudinal axis and a hoist axis of the jigsaw. Intuitive adjustment of the pliers guide unit, in particular at a right angle to the side surface of the jigsaw or the base plate unit, is possible. The jigsaw can be safely placed on its side while the pliers guide unit is being adjusted.

It is proposed that the base plate unit, in particular the base plate, forms a loss protection for the adjuster of the pliers guide unit and/or that the adjuster cannot be removed through the tool center opening. This can increase ease of use. In addition, fewer components, such as securing means, are advantageously required. Functional integration is advantageous.

It is proposed that the tool center opening is designed such that it narrows towards the adjuster, in particular narrows in a frustoconical shape and/or narrows from an advantageously outer inlet opening of the tool center opening into the base plate to an advantageously inner outlet opening, in particular towards the setting element or the sawing or chipping region. This enables good guidance of the tool to the adjuster. In particular, the tool is guided intuitively to the adjuster. The user does not need to see the adjuster. Time can be saved. User-friendliness is increased. Advantageously, only a rotary bearing of the tool, but not an axial offset, can be determined when inserting the tool to the adjuster.

It is proposed that the tool center opening is arranged separately from an air guide channel of the base plate unit or the base plate, in particular an air guide channel within the base plate unit or the base plate, in particular on the side of the base plate unit facing away from the workpiece contact surface when viewed in hoist axis direction. It is proposed that the tool center opening is arranged between an air guide channel of the base plate unit or the base plate, in particular a chip suction channel, and the housing unit of the jigsaw, in particular between an air guide channel or chip suction channel of the base plate unit and a connecting region of the base plate unit or base plate to the housing unit and/or to a gearbox flange or bearing flange. This allows the jigsaw to be designed very compactly and helps save installation space or room. A handle can sometimes be positioned closer to the saw blade. The pliers guide can be advantageously positioned close to the workpiece contact surface. Functional integration is advantageous. Components can be saved.

It is proposed that the tool center opening is arranged offset relative to a screw connection between the base plate unit and a gearbox flange or bearing flange of the jigsaw in the longitudinal axis direction of the jigsaw with respect to the front side or the front region of the jigsaw, in particular at a height of the screw connection when viewed in the hoist axis direction. Sometimes a contact surface of the pliers guide unit on the base plate unit is stiffened by the opposite contact of the gearbox flange or bearing flange on the base plate unit. The pliers guide unit can be positioned very close to the workpiece contact surface. Installation space can be saved.

It is proposed that two symbols for the parallel guide or break shoe guide of the saw blade are arranged on the base plate unit or the base plate, in particular to the right and left of the tool center opening or the through hole, advantageously in a plane parallel to the workpiece contact surface, advantageously arrows that are directed towards a saw blade or arrows that are directed away from a saw blade. This allows a user to intuitively recognize that turning the tool, in particular the hexagon wrench or the adjuster, to one side or clockwise reduces a distance and turning it to the other side or counterclockwise increases a distance. This can improve intuitive operation and ease of use.

It is proposed that the pliers guide unit, in particular the pliers guide, advantageously pliers arms and/or guide jaws of the pliers guide, is/are arranged between suction channels of the base plate unit or the base plate surrounding it on both sides, in particular suction channels surrounding it horizontally and/or parallel to the workpiece contact surface on both sides, advantageously suction channels surrounding it on both sides in the circumferential direction. This allows the pliers guide to be positioned very close to the workpiece contact surface, in particular despite the chip suction channels in the base plate unit. This can prevent the saw blade from moving. The saw blade can be guided very close to the point of penetration or saw blade entry into the workpiece by the pliers guide. The sawing result can be improved.

A chip breaker guard is proposed, or a jigsaw which has a chip breaker guard whose contour, in particular thickness, is adapted to the contour of the plier guide and/or wherein the plier guide and/or chip breaker guard provide one-sided or mutual overload protection, in particular plastic deformation protection, for one another. This enables functional integration to be achieved. This may increase the service life of the pliers guide and/or the chip breaker guard, as well as the compactness of the jigsaw.

### Pliers Guide

In connection with the aforementioned or independently thereof, a pliers guide for a jigsaw is proposed, comprising a first and a second pliers arm which are connected via a yoke and have guide jaws facing each other at their free ends. This makes it possible to advantageously provide a flexible pliers guide. This can take up little installation space. Space can therefore be saved. The pliers guide can sometimes be arranged very close to a workpiece contact surface or in a base plate, in particular laterally surrounded by suction channels or the like. The compactness of a jigsaw can be promoted. A center of gravity can sometimes be shifted further away from the workpiece contact surface.

It is proposed that the pliers arms, yoke and guide jaws are formed in one piece, in particular from metal, advantageously from steel or at least comprising iron.

It is proposed that the pliers guide has a clamp holder or adjuster holder for an adjuster on each pliers arm, in particular a screw, advantageously with a thread on the first pliers arm and a screw head contact surface on the second pliers arm. This results in functional integration, fewer components are required, in particular no additional clamping or slinging gear acting on the pliers arms.

It is proposed that the pliers guide has clamping and adjusting means support arms, in particular orthogonally starting from the pliers arms, in particular starting from a base plate contact surface plane of the pliers guide, in particular having a height that exceeds that of the pliers arms, advantageously by a multiple. This means that an adjuster does not weaken the pliers arms, for example by reaching through them. The dimensions of the pliers arms can be advantageously kept slim.

It is proposed that the clamp holders or adjuster holders are arranged vertically offset to an contact surface of the pliers guide for a base plate unit, advantageously a base plate, in particular a adjusting center longitudinal axis formed by the clamp holder or adjuster holder has a parallel offset to the contact surface of the pliers guide for the base plate unit. A spacing of the adjuster with the pliers guide installed in the jigsaw at an advantageous distance from a tool contact surface of the jigsaw can be made possible.

It is proposed that the pliers guide has a fixing center recess, in particular a screw hole, preferably an elongated screw hole, advantageously for fixing and/or adjusting the pliers guide on the jigsaw, in particular a base plate unit of the jigsaw. This allows the pliers guide to be calibrated or adjusted on the jigsaw. Advantageously, an adjustment can sometimes be corrected by a user if the pliers arms are bent. This can sometimes extend the service life of the pliers guide or jigsaw. The pliers guide can sometimes be replaced and adjusted by a user.

It is proposed that the pliers guide has a contact surface for frictional contact with the base plate unit, wherein the contact surface has positive-locking means, in particular, advantageously several, parallel webs which are arranged essentially parallel to the longitudinal alignment of the pliers guide or to the longitudinal alignment of the pliers arms, in particular in the region of the yoke, advantageously surrounding a fixing center recess, in particular arranged on both sides, advantageously arranged in mirror-like symmetry on both sides of the fixing center recess. This can improve the positioning of the pliers guide, in particular the yoke, relative to the base plate unit, in particular making it more stable against unintentional displacement. Advantageously, the pliers guide has iron or steel and the base plate advantageously has aluminum, so that the base plate deforms plastically when the pliers guide is fixed by the positive locking means. The strength can be increased. The robustness against impacts or blows to the pliers guide can also be increased.

It is proposed that the pliers arms are at least partially asymmetrical to each other, in particular in the region close to the yoke, and advantageously that the end regions of the pliers arms carrying the guide jaws and/or the guide jaws are symmetrical, in particular in mirror-like symmetry to each other. As a result, an asymmetrical displacement of the pliers arms can be achieved, in particular during adjustment by means of the setting element. Advantageously, the pliers guide can thus be optimized for one-sided clamping tool center holders or saw blade clamping systems. The same applies to the following three paragraphs.

It is proposed that the first pliers arm is designed to be more rigid than the second pliers arm, in particular wherein the first pliers arm is designed to be substantially rigid and the second pliers arm is designed to be substantially flexible.

It is proposed that the second pliers arm has a cross web transverse to the orientation of the pliers arm, in particular transverse to the orientation of the longitudinal axis of the pliers guide, in particular wherein the cross web is designed as a sling, in particular as a bending limiting means, advantageously as overload protection. The first pliers arm can form a counter-stop means for the second pliers arm. This can increase ease of use.

It is proposed that the first pliers arm is designed in sections with two arms, advantageously having an elongated hole extending in the longitudinal axis direction, in particular wherein the first pliers arm has in sections approximately a multiple width, advantageously three times the width of the second pliers arm, in particular the opposite second pliers arm.

It is proposed that the clamp holders or adjuster holders are arranged adjacent to the cross web of the second pliers arm and/or adjacent to the widened region of the first pliers arm, in particular on a side of the pliers guide facing away from the yoke and/or towards the guide jaws in the longitudinal axis direction. This can prevent overloading of the pliers arms. The rigidity can be increased. This allows, in particular, the clamp holders or adjuster holders to be reinforced.

It is proposed that the pliers guide has an insertion means, centering means and/or positive-locking means, in particular projecting essentially orthogonally from a contact surface for contact with the base plate unit, in particular at least partially tapering at an acute angle, in particular tapering at an acute angle to its free end. It advantageously extends transversely to a longitudinal axis of the pliers guide. It is advantageously thickened at opposite ends, in particular in the shape of a dumbbell. This allows an assembly aid to be provided. In addition, a positive-locking fit can be achieved between the base plate or base plate unit and the pliers guide. The rigidity can be increased. Unintentional displacement or displacement of the pliers guide relative to a base plate unit can be avoided.

It is proposed that the guide jaws have opposing guide surfaces for a saw blade of the jigsaw, in particular for opposing side surfaces of a saw blade, wherein the opposing guide surfaces widen towards each other in the longitudinal axis direction and/or transversely to the longitudinal axis direction of the pliers guide, in particular widen at an angle to each other. The guide jaws may also have guide surfaces aligned parallel to each other. These can widen in the longitudinal axis direction towards the side facing away from the yoke and/or widen in the hoist axis direction, in particular widening in the direction of the contact surface for the base plate unit. This allows saw blades of different widths and/or thicknesses to be guided safely. Even if the saw blade runs or twists, the pliers guide can remain undamaged. Interlocked saw blades of small widths can be picked up reliably. The application range of a jigsaw equipped with this can be increased.

It is proposed that the pliers arms and/or guide jaws have deflection surfaces, in particular in the transition region between a contact surface plane and the guide jaws. It is proposed that the pliers arms extend substantially in and/or transversely to the longitudinal axis of the pliers guide, in particular along the angled end region of the pliers arms carrying the guide jaws and/or along the guide jaws. Advantageously, they widen in the hoist axis direction, in particular towards a contact surface plane. Advantageously, they widen at an angle to each other. It is proposed that the deflection surfaces extending in and transversely to the longitudinal axis of the pliers guide merge into one another in an advantageously rounded manner. This prevents the pliers guide, in particular the pliers arms, from breaking when the saw blade runs off and/or when the jigsaw is operated with a damaged or bent saw blade. The service life can thus be extended.

It is proposed that the pliers guide has support surfaces that are thinner than the pliers arms in the hoist axis direction. These can, in particular in the yoke direction, protrude from the angled end region of the pliers arms carrying the guide jaws. This allows saw blades of small widths in particular to be guided safely. Reinforcement of the angled end regions can be provided.

A jigsaw with the aforementioned pliers guide is proposed. Advantageously, a pliers guide unit is accommodated on the base plate or base plate unit of the jigsaw, comprising the pliers guide and an adjuster, in particular an adjusting screw, for adjusting a transverse play of a saw blade which can be inserted into a tool holder of the jigsaw. In particular wherein the base plate has a lateral tool center opening, in particular a frustoconical tool center opening. Advantageous for enabling guided access to the adjuster of the pliers guide by means of a tool, in particular by means of an Allen key.

### Functional Interface

In connection with the aforementioned or independently thereof, a jigsaw having a housing unit and a base plate unit is proposed, wherein the housing unit comprises a motor housing, the longitudinal axis of which extends essentially parallel to a workpiece contact surface of the base plate unit. It is proposed that a functional interface, in particular an HMI, is arranged on an upper side of the motor housing facing away from the workpiece contact surface, at least for setting operating levels of a drive unit, in particular an electric motor, and/or for outputting operating parameters of the jigsaw, in particular comprising at least one display and/or at least one setting button. This can enable convenient operation of the functional interface. Above all, accessibility and/or visibility can also be ensured when the jigsaw is in operation.

It is proposed that the functional interface is arranged between a battery interface and a handle, in particular an advantageously pole-shaped handle surrounding the drive unit, a pole jigsaw, or between a battery interface and a bow-shaped handle of a bow jigsaw. This prevents accidental operation of the functional interface when gripping the jigsaw by the handle. A sometimes thickened battery interface region can prevent damage to the functional interface when the jigsaw is put down. Good visibility of the functional interface can also be ensured during operation.

It is proposed that the functional interface is arranged in the region of a widening and/or thickening of the motor housing, in particular a substantially square or rectangular widening and/or thickening, advantageously of an end region of the motor housing section of the jigsaw. As a result, the mostly flat or straight functional interface can be securely accommodated by and/or embedded in the motor housing. This may improve user-friendliness and increase stability or robustness.

It is proposed that the functional interface is arranged in relation to a longitudinal axis of the jigsaw or the motor housing unit opposite a second connecting region between the housing unit and the base plate unit, in particular a second connecting region which is mutually spaced from a first connecting region, in particular wherein an opening, in particular a reach-through opening, is formed between the connecting regions, the motor housing and the base plate unit. This allows forces to be transmitted to the base plate when operating the functional interface, in particular without the jigsaw having to be tilted or held

It is proposed that the functional interface is embedded in the housing unit, in particular in the upper side of the motor housing, or its surface, in particular so that it is free from contact with the flat surface in any position when the jigsaw is placed at least on a flat surface, in particular regardless of whether an exchangeable rechargeable battery pack is attached to the battery interface of the jigsaw or not. This may increase ease of use.

It is proposed that the functional interface, in particular in the case of a jigsaw designed as a bow jigsaw, is aligned at an angle to the workpiece contact surface and/or to the longitudinal axis, in particular at an angle of 10-15°, advantageously around 12.5°, in particular towards the front of the jigsaw and/or that the functional interface is accessible via an intermediate space, in particular a handle opening, formed between the motor housing and the bow handle. This may increase ease of use.

In connection with the aforementioned or independently thereof, a jigsaw having a housing unit and a base plate unit is proposed, having a blowing function for selectively supplying blow-off air, in particular air generated by a fan impeller, advantageously motor cooling air, to a sawing or chipping region of the jigsaw or to a blow-out opening of the jigsaw. It is proposed that the blow-out opening is arranged in the connecting region between the base plate unit or base plate and the housing unit. In particular, it is arranged in a parting surface, parting joint and/or parting plane between the base plate unit and the housing unit. This means that the blow-out opening is very close to the workpiece contact surface. When manufacturing the housing unit or housing shell and base plate to form the blow-out opening and/or air channels, these can be easily manufactured.

It is proposed that both the base plate unit and the housing unit, in particular a hoist housing section of the housing unit, form part of the blow-out opening, in particular a respective notched and/or channel-shaped region. The aforementioned advantages also apply here.

It is proposed that both the base plate unit and the housing unit form at least part of an air guide channel to the blow-out opening. Advantageously, they also form at least part of an air guide channel to the sawing or chipping region. As a result, components can be reduced and/or installation space can be saved.

It is proposed that the blow-out opening is intended to blow out blow-off air laterally and in the direction of a rear region of the jigsaw, advantageously at an angle of 30-80°, in particular 50-70°, preferably 60° to a longitudinal axis of the jigsaw, advantageously at an angle of 30-80°, in particular 50-70°, preferably 60° to a cutting or sawing plane of the jigsaw spanned by a hoist axis and a longitudinal axis of the jigsaw. This minimizes the amount of air blowing into the front region of the jigsaw. A flow loss can be kept to a minimum. When sawing, even with inverse cuts, a direct flow onto the user can be avoided.

It is proposed that a projection surface of a blowing function adjustment means or a blowing function adjusting swivel handle and/or a pendulum hoist adjuster or a pendulum hoist swivel handle, in projection along a hoist axis of the jigsaw, is superimposed on the blow-out opening. The installation space can thus be kept to a minimum. Accessibility of an adjuster, in particular directly above the blow-out opening, is made possible.

It is proposed that the blow-out opening is located relative to a sawing or parting plane of the jigsaw, which is spanned by a hoist axis and a longitudinal axis of the jigsaw, opposite a blowing function adjuster, in particular a blowing function adjusting swivel handle and/or opposite a pendulum hoist adjuster or a pendulum hoist swivel handle, or is located on the side of a blowing function adjuster, in particular a blowing function adjusting swivel handle and/or a pendulum hoist adjuster or a pendulum hoist swivel handle. In particular, adjusters can be mounted on both sides of the jigsaw in this way. This increases user comfort. Flow losses can be avoided due to short flow paths. Installation space can be saved.

It is proposed that the base plate unit is connected to the housing unit by means of two mutually spaced connecting regions which enclose the opening, in particular the reach-through opening. The blow-out opening is arranged in the region of and/or adjacent to the region of the opening, in particular the reach-through opening. This makes it possible to blow out the air at an angle. Installation space can be saved. Visibility of the workpiece to be processed can be improved.

It is proposed that a part, in particular a handle end, of a blowing function adjuster or a blowing function adjusting swivel handle and/or a pendulum hoist adjuster or a pendulum hoist swivel handle, is positioned at least partially in the region of the opening or reach-through opening. It is easy to operate even when the handle is gripped. The ergonomics of the jigsaw can be improved.

Further advantages and expedient embodiments can be found in the description of the figure and the drawings.

### DRAWINGS

Shown are:

FIG. 1 a jigsaw according to the invention as a so-called pole jigsaw in a perspective, schematic illustration,

FIG. 2 a jigsaw according to the invention as a so-called bow jigsaw, in a perspective, schematic illustration,

FIG. 3 a section of the jigsaw according to the invention as shown in FIG. 1,

FIG. 4 a sectional view of the jigsaw according to the invention as shown in FIG. 1 supplemented by a dust nozzle,

FIG. 5 a dust nozzle for the jigsaws according to FIG. 1 or 2 in a perspective, schematic illustration,

FIG. 6 the jigsaw according to FIG. 1 in a rear perspective schematic illustration, in particular to show a pendulum hoist adjuster,

FIG. 7 a section A-A of the jigsaw according to FIG. 1 in a more schematic illustration,

FIG. 8 a lateral view of the jigsaw according to FIG. 1 in a schematic illustration supplemented by a dust nozzle, or a lateral view of the jigsaw according to FIG. 4,

FIG. 9 a perspective schematic illustration of the jigsaw according to FIG. 1 or FIG. 8, in particular to show a blowing function adjuster,

FIG. 10 a section B-B of the jigsaw according to FIG. 1 in a schematic illustration,

FIG. 11 a section C-C of the jigsaw according to FIG. 1 in a schematic illustration,

FIG. 12 a pliers guide component in a schematic illustration view,

FIG. 13 schematic top view of the pliers guide component,

FIG. 14a section of the jigsaw according to FIG. 4 in a bottom view with the sliding plate or foot plate removed, in particular to show a pliers guide

FIG. 15 a simplified section of the jigsaw according to FIG. 1 in a sectional view, at least without saw blade to show a chip breaker guard connected to the pliers guide component,

FIG. 16a top view of the jigsaw according to FIG. 1 in a schematic illustration supplemented by the dust nozzle, or a top view of the jigsaw according to FIG. 4,

FIG. 17 Alternative embodiments of a jigsaw with arcuate support element,

FIG. 18 a schematic section normal to the hoist axis of the jigsaw according to FIG. 1 to better illustrate the blow-out opening.

### DESCRIPTION

The same reference numbers are used for the same or at least similar components in the different embodiments.

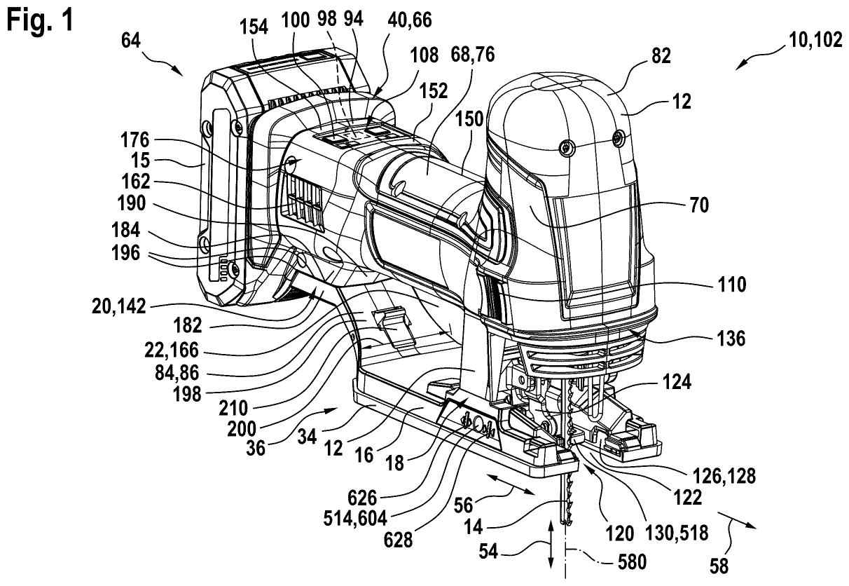

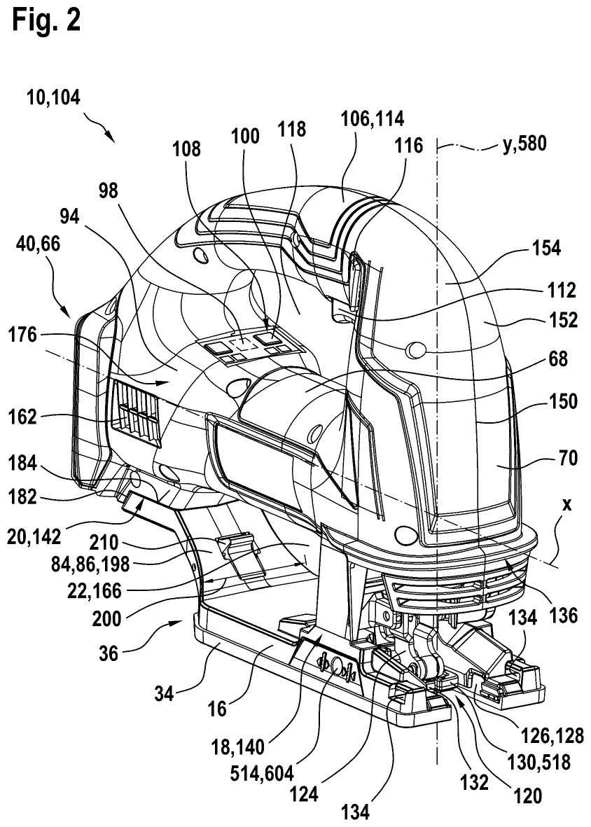

Like FIG. 2, FIG. 1 shows a hand-held power tool. They are each designed as jigsaws 10. FIG. 1 is designed as a so-called pole jigsaw 102, FIG. 2 is designed as a so-called bow jigsaw 104. They have a housing unit 12 and a base plate unit 36. The housing unit 12 comprises a motor housing section 68 and a hoist housing section 70.

According to FIG. 1, the motor housing section 68 of the pole jigsaw 102 also forms a handle 76, in particular a pole-shaped handle 78, hence also pole jigsaw 102. The hoist housing section 70 forms a further handle 80, in particular a knob handle 82, in an upper region or region of the jigsaw 10 facing away from the base plate unit 36 or workpiece contact surface 88. This serves, in particular, to support a second hand of a user, for example to increase the contact pressure or a contact force of the jigsaw 10 on a workpiece and/or to support the guidance of the jigsaw 10, in particular to support it with the second hand.

Alternatively, the jigsaw 10 according to FIG. 2 has a bow-shaped handle 106. This extends arcuately from the region facing away from the base plate unit 36 or the upper hoist housing section 70 to the region facing away from the hoist housing section 70 or to the rear region of the motor housing section 68. It forms a handle bar. It extends opposite the base plate unit 36 spaced from the motor housing section 68. It forms a handle opening 118 between itself and the motor housing section 68. A jigsaw 10 of this type is therefore also referred to as a bow jigsaw 104, in particular because of the handle bar. The hoist housing section 70 of the bow jigsaw 104 can also serve, in particular in a front region, to support a second hand of a user, for example to increase a contact pressure or a contact force of the jigsaw 10 against a workpiece and/or to support the guidance of the jigsaw 10.

The jigsaw 10, or pole jigsaw 102 according to FIG. 1, has an on/off switch 110 as an operating element. This can be used to switch a drive unit 46 of the jigsaw 10 on or off. Further adjusters and/or a functional interface 108 can be used, for example, to change or set an operating stage of the jigsaw 10. Advantageously, different operating stages can be selected or preset. The on/off switch 110 is typically arranged on the side, advantageously on both sides, of a hoist housing section 70 of the housing unit 12. It can advantageously be actuated with one hand, in particular with an index finger or a thumb of the hand, when gripping, in particular when gripping around the motor housing section 68 or the pole-shaped handle 78.

The jigsaw 10 or bow jigsaw 104 according to FIG. 2, on the other hand, typically has an accelerator switch 112 as an operating element. The accelerator switch 112 is arranged on the bow-shaped handle 106 and/or in the transition region to the hoist housing 70. It can be used to control or regulate a motor speed or hoist rate of the jigsaw 10 according to a deflection of the accelerator switch 112 by a user. In particular, the accelerator switch 112 is arranged at the transition of the handle bar housing section 114 with the hoist housing section 70. Advantageously, an enabling switch 116 must be actuated in advance to actuate the accelerator switch 112. The bow jigsaw 104 also has a functional interface 108, via which further machine tool parameters can be changed or set.

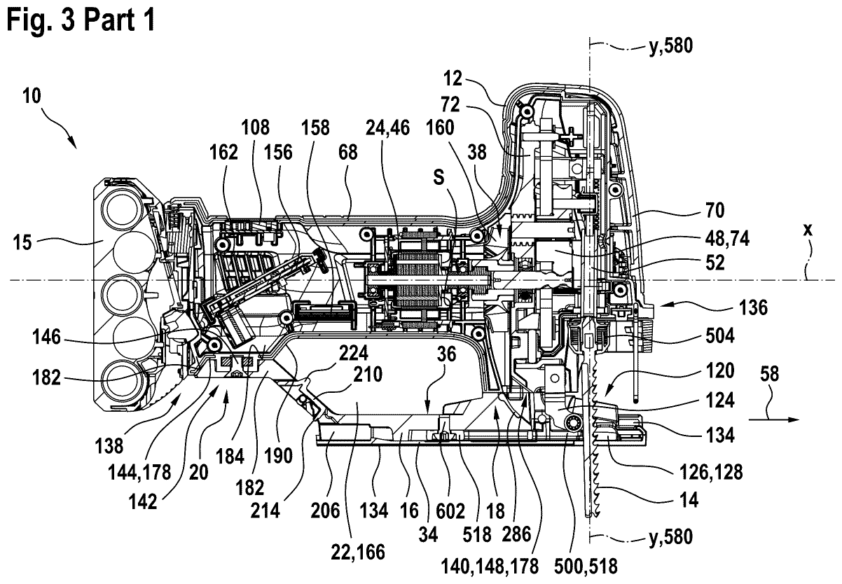

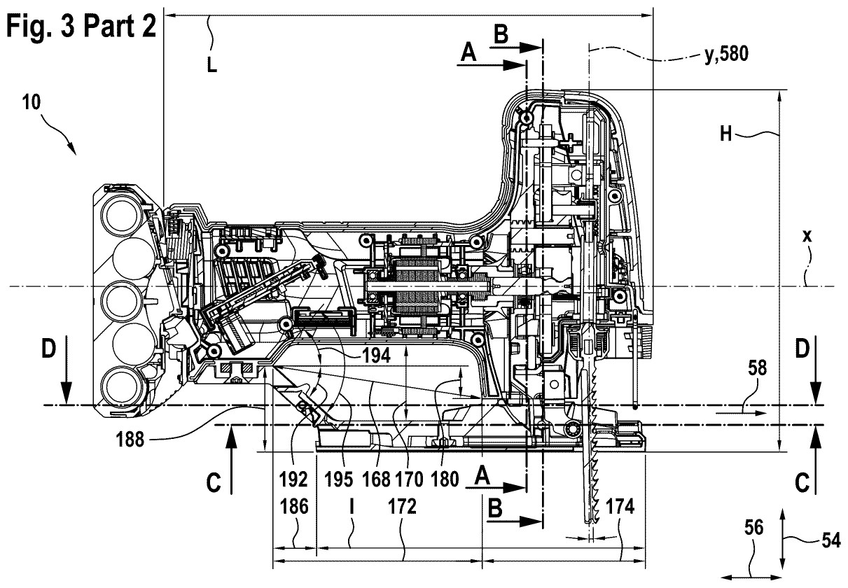

Apart from the aforementioned differences and the other differences evident from FIGS. 1 and 2 with regard to the bar and bow embodiment of the jigsaws 10, the jigsaws 10 do not differ significantly with regard to the further structure described below. Therefore, FIGS. 3-16, which are used for a more detailed further description, are based on the jigsaw 10 or pole jigsaw 102 according to FIG. 1, but are to be applied to the jigsaw 10 or bow jigsaw 104 according to FIG. 2.

The jigsaw 10 is intended to drive a processing tool. The processing tool is a saw blade 14 or a jigsaw blade. During operation of the jigsaw 10, the saw blade 14 performs a lifting movement 54 or a sawing movement, as is known. The jigsaw 10 therefore belongs to the category of hacksaws, such as reciprocating saws. As here, a pendulum movement 56 can also be superimposed on the lifting movement 54. It is therefore a pendulum action jigsaw. The saw blade 14 can therefore perform an advantageously adjustable orbital movement. During sawing, the jigsaw 10 is moved in a known manner in a feed direction 58 and is at least guided and/or pushed by a user.

A battery 15 serves as the power source for the jigsaw 10. This is arranged at the rear region 64 of the jigsaw 10 or the housing unit 12 of the jigsaw 10. In particular, at an end of the motor housing section 68 facing away from a front region 136 or the sawing or chipping region 120. The battery 15 is an exchangeable rechargeable battery pack, in particular an 18V exchangeable rechargeable battery pack. The battery 15 can be accommodated at an interface 40 or battery interface 66 of the jigsaw 10. The battery 15 has a battery interface corresponding to the battery interface 66 of the jigsaw 10. Alternatively, the jigsaw 10 could also be mains-powered. In this case, it would typically have a mains cable input in the rear region 64. In particular, the jigsaw 10 could also have integrated rechargeable batteries. These could be charged via USB or another charging interface, for example. Other energy sources for supplying power to the jigsaw are also conceivable. In principle, other drive mechanisms, e.g. linear, piezo or other types of drive are also conceivable.

The base plate unit 36 of the jigsaw 10 comprises a base plate 16. A sliding plate or foot plate 34 is fixed to the base plate 16. The sliding plate or foot plate 34 is primarily used for low-friction guidance of the jigsaw 10 on a workpiece (not shown). The sliding plate or foot plate 34 is supported here via the stable structure of the base plate 16. In particular, the base plate 16 is formed from a solid material for this purpose, for example comprising metal, in particular aluminum. The sliding plate or foot plate 34 can be formed from a plastic, for example, as is the case here. The base plate and foot plate 16, 34 could also be formed in one piece. The base plate and foot plate 16, 34 of the jigsaw 10 serve to support and guide the jigsaw 10 against a workpiece to be machined (not shown). They form a base plate unit 36. The base plate unit 36 can advantageously also comprise a support element 84. It is advantageously formed in one piece with the base plate 16. It is formed between the base plate 16 and the housing unit 12. It advantageously connects these in a supporting manner. It is advantageously formed from the same material as the base plate 16, in particular comprising aluminum. It serves to support the housing unit 12 in a region facing away from the sawing region 120, or a rear region 64 of the jigsaw 10. The base plate 16, or the base plate unit 36, serves to support the housing unit 12 relative to a workpiece. The base plate unit 36 or the base plate 16 does not have to be made of solid material. For example, it can have webs, channels or ribs or the like to avoid weight. The base plate unit 36 is advantageously not telescopic or height-adjustable relative to the housing unit 12.

The saw blade 14 protrudes through a forked front recess 122 of the base plate 16 or base plate unit 36. This region forms the sawing or chipping region 120 of the jigsaw 10. The pendulum movement 56 can be superimposed on the saw blade 14 in a known manner for the lifting movement 54 via a pendulum roller lever 124. The sawing or chipping region 120 can advantageously optionally be supplied with blow-off air or not, in particular in order to blow away chipping material, for example sawdust. This can ensure improved visibility of the workpiece, the cut and/or the sawing or chipping region 120. Suction air can also be extracted, for example through air channels in the base plate 16, in particular via suction openings 128 on the sawing or chipping region 120. A transverse guide of the saw blade 14 can advantageously be provided via a pliers guide 518, or a pliers guide unit 500, or via lateral clamping, sliding and/or guide jaws 132, 530, 532. The base plate 16 advantageously also has a device 134 for attaching a parallel stop (not shown here).

FIG. 3 shows a section through the jigsaw 10 according to FIG. 1 in a parting plane 150 or sawing plane 608. The parting plane 150 is spanned by the longitudinal axis x of the jigsaw or motor rotation axis and the hoist axis y, 580. The same applies to the sawing plane. FIG. 3 shows the internal structure of the jigsaw 10. The drive train 38 of the jigsaw 10 comprises at least the drive unit 46, a hoist gear unit 48 and a output unit 52. The drive train 38 is arranged inside the housing unit 12. The motor housing 68 or the motor housing section 68 accommodates at least the drive unit 46 or the electric motor 24 of the jigsaw 10. The motor housing 68 accommodates a communication module 158 or KoMo. This is advantageously provided for a wireless connection with an external unit. The communication module, or KoMo for short, is intended for data exchange. The motor housing 68 accommodates a control or regulating unit 156 or control or regulating electronics. This is advantageously arranged transversely to the longitudinal axis x in the motor housing 68. It is advantageously arranged between the communication module 158 and a functional interface 108 of the jigsaw 10. In particular, the control or regulating electronics and the functional interface 108 are arranged in a rear region 64 of the motor housing 68. Advantageously adjacent to the battery interface 66 and/or between the battery interface 66 and the drive unit 46 of the jigsaw 10. Advantageously, the functional interface 108 is arranged opposite a second connecting region 20 with respect to the longitudinal axis x, as will be explained further below.

A fan impeller 160 is located in a transition region between the motor housing 68 and the hoist housing 70. The fan impeller 160 is driven by the drive unit 46. It draws in cooling air at least for the control or regulating unit 156 and/or the drive unit 46, but sometimes also the KoMo 158 or the functional interface 108, in particular via ventilation slots 162 in the motor housing 68. It advantageously supplies blow-off air either to the sawing or chipping region 120 or to the environment.

The hoist housing 70 or the hoist housing section 70 of the housing unit 12 accommodates at least one hoist gear 74 or a hoist gear unit 48 of the jigsaw 10. A gearbox flange or bearing flange 72 or support frame of the hoist gear 74 is arranged within the hoist housing section 70. This gearbox flange or bearing flange 72 is firmly connected to the base plate 16, in particular screwed via the screw connection 612. In principle, it could also be pivotably connected to the base plate 16. It advantageously carries at least parts of the drive train 38 of the jigsaw 10, in particular the hoist gear components and sometimes the output. It advantageously also carries and/or positions the hoist housing 70, in particular which is connected to the gearbox flange or bearing flange 72 via corresponding positive-locking elements in the housing shells 152, 154 when the housing shells 152, 154 are connected or screwed together. The gearbox flange or bearing flange 72 thus at least partially positions and/or connects the housing unit 12 to the base plate 16 or to the base plate unit 36.

The rotating drive movement of the drive unit 46 or the electric motor 24 is converted in a known manner by the lifting mechanism, in particular by means of the hoist gear 74, into a reciprocal movement or lifting movement of an output or the output unit 52 and finally of a tool holder or saw blade holder 164. Different saw blades 14 can be inserted into the tool holder or saw blade holder 164 of the jigsaw 10, in particular saw blades of different thicknesses and/or different for different applications, for example.

### Mutually Spaced Connecting Regions

It is proposed that the housing unit 12 of the jigsaw 10 is longer than the base plate 16 in the longitudinal direction x, or in the direction of a longitudinal axis x of the jigsaw 10. Advantageously, the housing unit 12 is at least 25%, advantageously around 40-60% longer than the base plate 16. The longitudinal axis x runs in the main direction of extension or in the longitudinal direction x of the jigsaw 10. The longitudinal axis x of the jigsaw 10 is essentially coaxial with the axis of rotation x of the drive unit 46 or motor axis 28 of the electric motor 24 of the jigsaw 10. It extends essentially parallel to a support plane or workpiece contact surface 88 of the base plate or foot plate 16, 34 of the jigsaw 10. It extends essentially in the parting plane 150, which advantageously is also the parting plane 150 of two housing shells 152, 154 of the jigsaw 10. A longitudinal extension L of the housing unit 12 extends from the front region 136 to the rear region 138 of the jigsaw 10, in particular from the end of the front region 136 of the hoist housing 70 or hoist housing section 70, to the end of the rear region 138 of the motor housing 68 or motor housing section 68. A longitudinal extension L of the base plate 16 also extends essentially from the front region 136 of the jigsaw 10 in the direction of the free end of the motor housing 68, but ends earlier. The longitudinal extension L of the housing unit 12 is around 245 mm. The longitudinal extension 1 of the base plate 16 is around 165 mm. Thus, the longitudinal extension L of the housing unit 12 is here exemplarily around 50% more than the longitudinal extension 1 of the base plate 16.

The base plate 16 and/or base plate unit and the housing unit 12 are connected to each other by means of two connecting regions 18, 20 mutually spaced in the longitudinal direction x. They are connected to each other in the parting plane 150 via mutually spaced connecting regions 18, 20. In particular, they are rigidly connected to each other. In particular, they are bracingly interconnected. The connecting regions 18, 20 advantageously have bearing and/or fixing points 140, 142. Corresponding contact surfaces, positive-locking means and/or connecting means, in particular clamping and/or positive-locking surfaces 144 and/or screws 146, serve in particular as bearing and/or fixing means. A first connecting region 18 is arranged in the transition region 148 between hoist housing 70 and base plate 16—so to speak adjacent to the sawing or chipping region 120 or in the lower front region of the jigsaw 10. The support is located between the base plate 16 and a bearing or gearbox flange 72, which are screwed together via the screw connection 612. The second connecting region 20 is in the rear region or rear region 64 of the jigsaw 10 or the motor housing 68. The support between the base plate 16 and the housing unit 12 is provided via the motor housing 68, in particular via the support element 84 which is arranged between the base plate 16 and the housing unit 12, in particular is formed integrally with the base plate 16. The connecting regions 18, 20 are designed to be rigid or non-pivoting. In principle, however, a pivotable and fixable bearing could also be provided, for example if the base plate unit 36 or the base plate 16 is to be pivotable relative to the housing unit 12, e.g. in order to perform an angled cut in the feed direction 58 with the jigsaw 10, in particular relative to the workpiece surface or workpiece contact surface. The connecting regions 18, 20 are arranged at a distance from each other along the longitudinal axis x of the jigsaw 10.

A region between the connecting regions 18, 20 is open between the base plate 16 and the housing unit 12. An opening 166 is thus formed between the base plate 16, housing unit 12 and the connecting regions 18, 20, in particular a reach-through opening 22. In particular, regions of the base plate 16, the motor housing section 68 and the hoist housing section 70 facing each other enclose the opening 166 or the reach-through opening 22 via the connecting regions 18, 20. In particular, they enclose these substantially completely, advantageously by 360°, in conjunction with the support element 84 within the parting plane 150 During handling, in particular when gripping the pole jigsaw 102, fingers of a user's hand can reach into this reach-through opening 22, in particular to securely grip around the motor housing 68. Sometimes an entire user's hand can be inserted through the opening.

A length l of the base plate 16 is advantageously around 100-200 mm, in particular around 150-180 mm, advantageously around 165 mm. A longitudinal extension L of the jigsaw 10 is advantageously more than 200 mm, in particular around 200-300 mm, advantageously 220-270 mm, preferably around 245 mm. A width B of the jigsaw 10 is advantageously 70-90 mm, in particular 80-82 mm. A height H of the jigsaw 10 has, depending on the embodiment, e.g. in the case of the pole jigsaw 102 around 160-200 mm, advantageously around 180 mm, e.g. in the case of a bow jigsaw 104 around 180-220 mm, advantageously around 200-205 mm.

The connecting regions 18, 20 have a distance 168 of at least 25% of the length l of the base plate 16, advantageously 25-75% of the length l of the base plate 16. In particular, the connecting regions 18, 20 have a distance 168 of at least 25% of the longitudinal extension L of the jigsaw 10, advantageously 30-50% of the longitudinal extension L of the jigsaw 10. The connecting regions 18, 20 advantageously have a distance 168 of at least 50 mm, preferably of at least 70 mm, advantageously around 75-125 mm. Here, a distance 172 in the longitudinal axis direction x between the two connecting regions 18, 20 is around 100-105 mm. The first connecting region is arranged adjacent to the front-side sawing or chipping region 120 of the jigsaw 10. The second connecting region 20 is arranged at a distance therefrom in the direction of the rear region of the jigsaw 10. The connecting regions 18, 20 each extend over a connecting surface. In particular, a connecting surface transverse to and in the longitudinal axis direction x. The first connecting region 18 advantageously extends over a length in the longitudinal axis direction of 30-40 mm or 10-20%, in particular 12-17% of the length L of the jigsaw 10. It advantageously extends over a width transverse to the longitudinal axis direction x of 40-70 mm or 20-30% of the length L of the jigsaw 10. The second connecting region 18 advantageously extends over a length in the longitudinal axis direction of 30-40 mm or 10-20%, in particular 12-15% of the length L of the jigsaw 10. It advantageously extends over a width transverse to the longitudinal axis direction x of 30-40 mm or 15-20%, in particular 15-17% of the length L of the jigsaw 10. In the connecting regions 18, 20, contact surfaces, in particular of the housing wall of the housing unit 12 and the base plate unit 36 or the base plate 16, advantageously come into contact.

The opening 166 or reach-through opening 22 has a height 170 of 20-30% of the length l of the base plate 16, or a height 170 of 20-30% of the height H of the jigsaw 10, or around 10-20%, advantageously around 15% of the length L of the jigsaw 10. The height 170 of the opening 166 between the base plate 16 and the motor housing 68 is advantageously around 35-45 mm, in particular around 40 mm. The shape of the opening 166 as viewed in the parting plane 150 is at least partially oval and/or partially rectangular and/or, in particular adjacent to the second or rear connecting region 20, tapered. Thus, the opening 166, in particular with respect to the pole jigsaw 102, in particular in which the motor housing 68 also forms the handle 76, can be easily gripped around and/or at least with some fingers, advantageously the middle finger, ring finger and little finger. Viewed in the longitudinal direction x of the jigsaw 10, the opening 166 begins approximately centrally above the base plate 16. It protrudes beyond the base plate 16 at the rear. A distance 174 of the opening 166 to the saw blade 14 is only around 45-55 mm, in particular around 15-25%, advantageously around 20% of a length L of the jigsaw 10. A distance of the opening 166 to the front end of the jigsaw 10 is around 75-85 mm, advantageously around 80 mm. This allows the hand, in particular the guide hand and its fingers, to be positioned relatively close to the saw blade 14. This grip position enables precise work. Stable and/or precise guidance of the jigsaw 10 is made possible. The jigsaw 10 can be easily controlled, in particular to follow a desired cutting line.

A center of gravity S of the jigsaw 10 advantageously comes to lie within the opening 166 or reach-through opening 22 or between the opening 166 and the longitudinal axis x, with or without the battery 15 applied to the jigsaw 10.

Further, the first connecting region 18 is advantageously adjacent to the front-side sawing or chipping region 120 of the jigsaw 10. The second connecting region 20 advantageously adjoins the rear-side battery interface region 66 of the jigsaw 10 and/or is arranged adjacent to a rear region 138 of the motor housing section 68 of the housing unit 12. The first connecting region 18 is arranged in the region of a support frame connected to the base plate 16 and/or the gearbox flange or bearing flange 72 of the hoist gear 74 of the jigsaw 10. The second connecting region 20 is advantageously arranged below an advantageously thickened, in particular substantially squarely thickened, end region 176 of the motor housing section 68 of the jigsaw 10. The squarely thickened motor housing section 68 thus provides a very solid abutment for the support element 84. In addition, the functional interface 108 can be accommodated opposite the connecting region 20, advantageously surrounded and therefore protected by the squarely thickened motor housing section 68. In the case of the bow jigsaw 104, the forces acting from the bow-shaped handle 106 can be transmitted, in particular via the thickened region, to the second connecting region 20—from there then via the support element 84 to the base plate 16. In the case of the bow jigsaw 104, the connecting regions of the bow-shaped handle 106 are advantageously at least partially overlapping with the connecting regions 18, 20 to the base plate unit 36 when viewed in the longitudinal axis direction x.

Separating or dividing joints 178 of the connecting regions 18, 20, have a vertical offset 180 (transverse to the longitudinal axis direction x) in the direction of the hoist axis y, 580 and/or a horizontal offset (in the longitudinal axis direction x) or a distance 172 from one another, in particular a vertical offset 180 of 15-20 mm, in particular around 17-18 mm and/or a horizontal distance 172 or offset of 95-105 mm, in particular around 100 mm.

The housing unit 12, in particular the motor housing section 68, is connected to the base plate 16 via the support element 84. The support element 84 is advantageously exposed, in particular a support leg or support arm 86 of the support element 84 is exposed. The support leg or support arm 86 advantageously extends between the housing unit 12 and the base plate 16. The support element 84 is not surrounded by the housing unit 12 or base plate 16 in a region, in particular in the region of the support leg or support arm 86. In particular in a circumferential direction around the support element 84 or the support leg 86. It is visible and/or accessible to a user. In particular, the support leg 86 has a smooth surface 198, in particular a smooth surface 198 facing the housing unit 12, advantageously the motor housing 68 and or hoist housing 70. On the side facing away from or opposite the housing unit 12, it/he may advantageously have support ribs or the like. The support element 84 has in particular a support surface 184 and/or a free end 182, which forms the second connecting region 20 and/or an contact surface to the housing unit 12, in particular to the motor housing section 68, sometimes at least also supporting it with respect to the battery interface 66. The support element 84 is a supporting, rigid element. It is formed integrally with the base plate 16. It is made of metal, in particular an aluminum alloy.

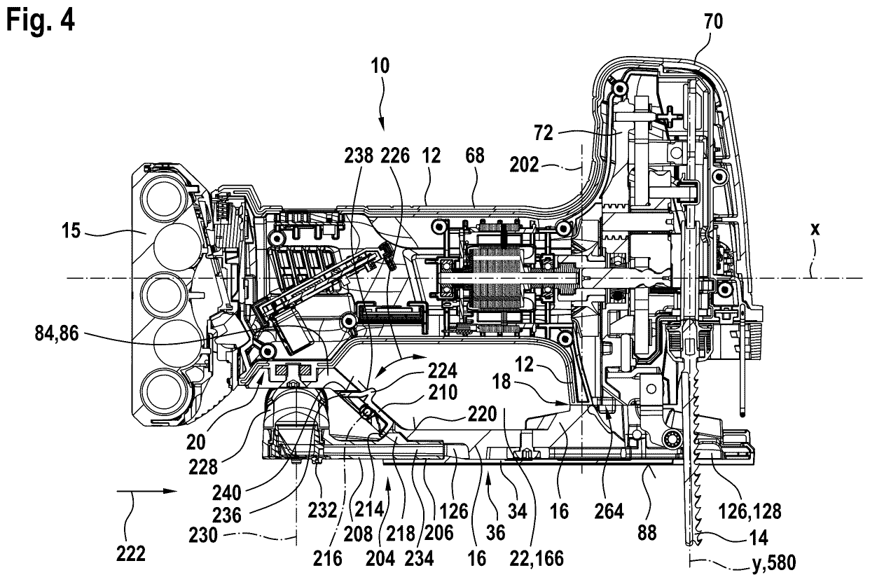

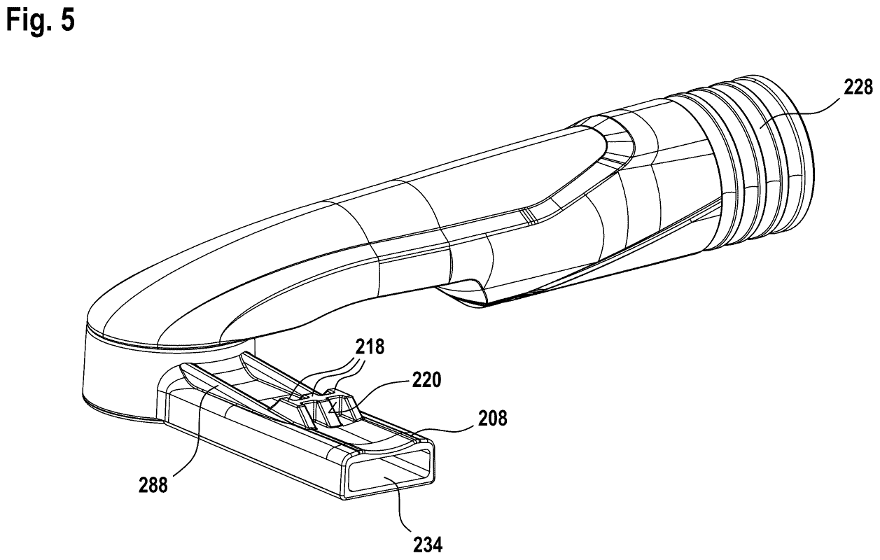

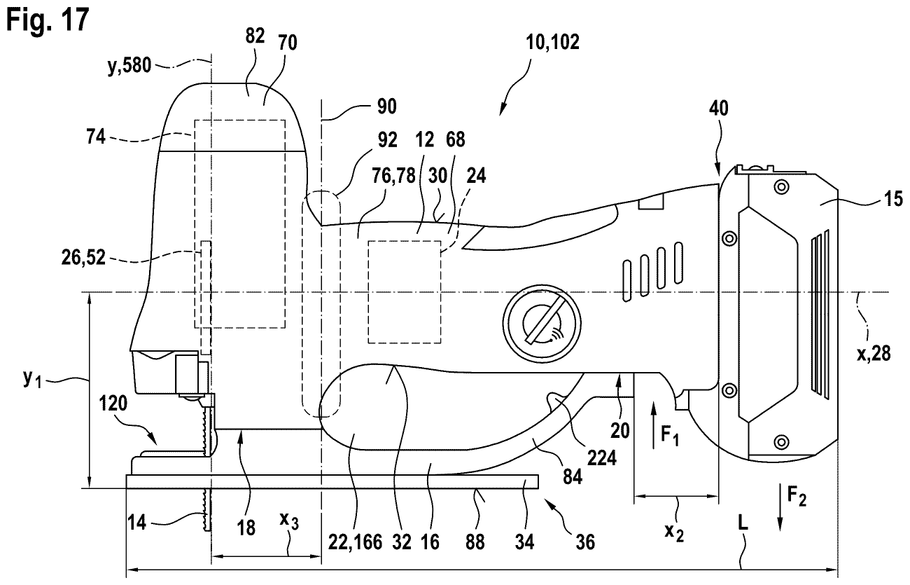

It is proposed that the support element 84, in particular a support leg 86 or support arm of the support element 84, forms, in relation to the base plate (16) and/or the housing unit (12), an offset shape or a shape extending obliquely to the longitudinal axis x and/or to the workpiece contact surface of the base plate and/or foot plate 16, 34. It can also form an arcuate shape, as shown, for example, in FIG. 17. In this case, the curved shape can be convex starting from a workpiece contact surface of the base plate and/or foot plate 16, 34, or concave when viewed from the housing unit 12. The offset, oblique and/or arcuate shape allows forces to be transmitted from the rear region of the motor housing 68, in particular from the region of the battery interface 66 and/or forces from the rod handle 78 or bow-shaped handle 106 to the base plate 16. In particular, without being transmitted via the hoist housing 70. This makes the jigsaw 10 very stable. Nevertheless, it enables a relatively short base plate or foot plate 16, 34. A high maneuverability of the jigsaw 10 relative to the workpiece or a high visibility of the workpiece can be ensured. A suction nozzle 208 see FIGS. 4 and 5 can be adapted without protruding beyond the jigsaw 10 in the longitudinal axis direction x, in particular towards the rear.

Advantageously, the support surface 184 or the free end 182 of the support element 84 is arranged vertically and longitudinally offset relative to the rear end of the base plate 16. The support element 84, in particular the support leg 86, the support surface 184 and or the free end 182 of the support element 84 are arranged at a distance, advantageously vertically and/or longitudinally offset from the workpiece contact surface of the base plate and/or foot plate 16, 34, or the transition region of the support element 84 to the base plate 16.

The support surface 184 for the housing unit 12 is formed substantially parallel to the workpiece contact surface of the base plate and/or foot plate 16, 34 or parallel to the longitudinal axis x. The support surface 184 advantageously has an axial and vertical offset 186, 188 relative to the base plate 16. It is connected to the base plate 16 in particular by the oblique and/or offset support leg 86 or support arm 86. The support leg 86 or support arm 86 can also be arcuate, as can be seen, for example, in the alternative jigsaw structure of FIG. 17.

The connection of the support element 84 to the base plate 16 and of the support element 84 to the housing unit 12 or the motor housing 68 have a horizontal offset relative to one another, and advantageously also a vertical offset.

The support leg or support arm 86 forms an angle 192 with the workpiece contact surface of the base plate and/or foot plate 16, 34 and/or a support surface 184 of the support element 84 for the housing unit 12. Advantageously, a support angle 192 of 30-60°, in particular of around 40-50°. The support surface 184 of the support element 84 advantageously also forms an angle 194 with a support leg 190 of the housing unit 12. This support leg 190 also leads into the thickened region 176 of the housing unit 12 or the motor housing. The angle 194 here is advantageously 30-60°, in particular 40-50°. This results in a large acute, sometimes even obtuse opening angle 195 between the motor housing 68 and the support element 84 or support leg 86. The opening angle 195 is advantageously around 50-110°. It is the opening angle between the housing unit 12 and the support element 84 towards the opening 166 or reach-through opening 22, in particular viewed in the parting plane 150 (see, for example, FIG. 3).

The support element 84 and the housing unit 12 advantageously have corresponding positive-locking geometries 196, in particular providing support in at least two spatial directions extending perpendicularly or obliquely to each other, in particular providing support perpendicularly or obliquely to the longitudinal axis direction x and in the hoist axis direction y of the jigsaw 10. Advantageously, the housing unit 12 has a positive-locking geometry 196 providing support to battery interface 66. Advantageously, the free end of the support element 84 supports it, in particular at an angle to the longitudinal axis direction x, in particular by means of corresponding oblique surfaces. The support element 84 or the support surface 184 can be recessed in the housing unit 12 or the motor housing 68, in particular recessed in the rear region 64 of the housing unit 12. Axial and vertical impact forces, especially those acting, for example, when the jigsaw 10 accidentally falls to the ground, in particular when it strikes the battery 15 fixed to the jigsaw 10 or the base plate 16, can be transmitted between the housing unit 12 and the base plate 16 in a fracture-preventing manner, in particular also by the battery interface 66 supported thereby.

It is proposed that the housing unit 12 or the motor housing 68 is designed to be thicker in the rear region 64 or adjacent to or above the connecting region 20, in particular adjacent to or above the support element 84, in particular to the support surface 184. It is proposed that it is at least substantially square or rectangular in shape. In particular, a height and a width of the motor housing 68 are increased in this region. Sometimes the housing unit 12 can taper in the immediate vicinity of the connecting region 20, advantageously in order to enable a transition to the support element 84 with the same surface. In the rear region 64 or connecting region 20, the motor housing 68 has a greater width and/or height or a larger circumference in the circumferential direction around the longitudinal axis x than in the motor housing region 68 surrounding the drive unit 46. Advantageously having a larger circumference than in the region of the pole-shaped handle 76.

The support element 84 is designed such that it tapers from the base plate 16 towards the housing unit 12, in particular tapers concavely, in particular has an advantageously concavely decreasing width 200. The width thus decreases transversely to the longitudinal axis x or transversely to the parting plane 150. In particular, the support leg or support arm 86 tapers between the base plate 16 and the support surface 184, advantageously concavely, or reduces its width 200. As a result, the support element 84, in particular the support leg or support arm, forms a lateral contact surface, in particular on both sides, for the arm of a user during inverse sawing with the jigsaw. The handle 86 can be gripped without having to bend a wrist of the user. This can improve the guidance of the jigsaw 10, in particular the pole jigsaw 102, during inverse cutting, that is, sawing a horizontally aligned workpiece from below, in particular to minimize tear-out at the top of the visible surface of the workpiece. The concave shape is particularly oval. This allows the user's forearm, which is also typically oval in shape, to rest against it. The support element forms a contact surface, so to speak, for the user's forearm. Starting from the base plate, the support element has a width that decreases towards the housing unit, in particular a concavely decreasing width. Effect: Inverse sawing—arm has space to reach the handle; provides contact surface.

The support element 84 protrudes axially beyond the base plate 16, i.e. in the longitudinal axis direction x, in particular on a side of the base plate 16 facing away from the sawing region 120. In particular, it has a vertical offset towards the longitudinal axis x of the motor housing section 68. The base plate 16 is essentially flush with the front or the front region 136 of the jigsaw 10.

A damping element (not shown here), for example as a damping disk or pad, can also be arranged between the support element 84, in particular the support surface 184 of the support element 84, and the housing unit 12, in particular the motor housing 68. This can improve the vibration propagation between the base plate 16 and the housing unit 12, or sometimes dampen shocks when the jigsaw 10 falls. In some cases, noise development may also be positively influenced. For the purposes of this disclosure, an arrangement with an intermediate damping element is still to be understood as a rigid connection between base plate 16 and housing unit 12.

### Dust Nozzle

A jigsaw 10 with a base plate unit 36 and a suction unit 204 (see in particular FIG. 4) is proposed, advantageously a jigsaw 10 having a base plate unit 36 with a suction unit 204. The base plate unit 36 has at least one base plate 16, advantageously in conjunction with a foot plate or sliding plate 34. Particularly advantageously, the base plate unit 36 comprises the base plate 16 and a support element 84, which is advantageously designed integrally with the base plate 16. The foot plate or sliding plate 34 is connected to the base plate 16 in particular in a detachable or replaceable manner, for example by screwing. It advantageously serves as a workpiece contact surface, in particular comprising, advantageously made of plastic. The base plate and foot plate 16, 34 can also be designed as one piece, for example made of metal. As already explained above, the support element 84 advantageously protrudes axially beyond the base plate 16, in particular on a side of the base plate 16 facing away from the sawing region 120. It is advantageously oblique or arcuate. It advantageously connects the housing unit 12, in particular the motor housing 68, to the base plate 16. It is advantageously formed in one piece with the base plate 16. It is formed at a distance from the workpiece contact surface of the base plate or foot plate. A distance from the workpiece contact surface increases in at least one section, in particular a section of the support leg, with increasing distance from the base plate. The other aforementioned explanations of the various components of the jigsaw 10 are also applicable here.

The suction unit 204 has at least one suction nozzle holder 206. The suction unit 204 is arranged in particular in the base plate unit 36, advantageously formed at least in part by the base plate and foot plate 16, 34. It is designed for detachable connection to a suction nozzle 208. The suction nozzle 208 can be detachably connected to the jigsaw 10 or the suction nozzle holder 206. The suction nozzle 208 is, so to speak, an adapter between the jigsaw 10 and a suction hose, for example of a vacuum cleaner. The suction nozzle 208 can be connected to the jigsaw 10 in order, for example, to extract sawdust, in particular through the base plate 16 or the base plate unit 36.

The jigsaw 10 has a movable, in particular pivotably mounted fastening element 210. It is intended for positive-locking fixation of the suction nozzle 208. For this purpose, it has a displaceable latching means 214, in particular a pivoting latching means 214 tapering towards the tip. The latching means 214 is pivotably mounted about a pivot axis 216. It is advantageously spring-loaded, in particular by a torsion spring (barely visible in the sectional view of FIG. 4), advantageously into its latching position, in particular into its initial position. One end of the torsion spring is supported on the jigsaw 10, in particular the support element 84 of the jigsaw 10. The other end is on the latching means 214. The latching means 214 is shown in its latching position or its initial position. It is latched with a corresponding latching means 218 of the suction nozzle 208. It rests against an oblique surface of the corresponding latching means 218. The corresponding latching means is formed on an upper side of the suction nozzle 208 as a positive-locking means or as an elevation. The suction nozzle 208 is pushed or inserted into the suction nozzle holder 206. The latching means 214 blocks the suction nozzle 208 against unintentional falling out or removal. The corresponding latching means 218 has a further oblique surface 220, which is intended to automatically pivot the fastening element 210 out of the initial position when the suction nozzle 208 is inserted (in the direction of the arrow 222) into the suction nozzle holder 206. When fully inserted, the fastening element 210 automatically snaps back into its initial position or latching position due to the spring pre-tensioning and fixes the suction nozzle 208 to the jigsaw 10 or the base plate unit 36. Guiding and/or clamping and/or stiffening means 288 are provided on the suction nozzle 208, in particular on the side of the positive-locking or latching means 218, in particular as viewed from the air guide channel 234 (see in particular FIG. 5). When the suction nozzle 208 is inserted into the suction nozzle holder 206, these can provide a vertical mounting of the suction nozzle 208 with as little play as possible relative to the suction nozzle holder 206. They can also stiffen the suction nozzle 208. Alternatively, they can also guide it in corresponding grooves, for example in the suction nozzle holder 206, or the like.

To release, the user actuates a handle element 224. The handle element 224 is formed integrally with the fastening element 210. It is arranged on the opposite side of the pivot axis 216 to the latching means 214. The fastening element 210 has a rocker-like design. However, the latching means 214 extends at the end of the rocker beam in the opposite direction to the handle element 224 in the region of the opposite end of the rocker beam. The end of the fastening element opposite the latching means 214 has, so to speak downstream of the handle element 224 or at the free end, a further positive-locking element, in particular a stop end 236 extending obliquely to the rocker bar and/or obliquely to the latching means 214. It is intended to strike the jigsaw 10, in particular the support element 84 of the jigsaw 10, in the latching position and the pivoting or release position. Advantageously, a deflection of the fastening element 210 is limited, in particular so that it cannot inadvertently collide with the suction nozzle 208 when it is attached or removed.

The handle element protrudes into an opening 166, or a reach-through opening of the jigsaw. By pressing on the handle element 224 in the swivel direction 226, in particular starting from the opening 166 or the reach-through opening 22, the detent means connection 214, 218 is released and the suction nozzle 208 can be removed from the suction nozzle holder 206. A surface 238 of the handle element 224 facing away from the latching means 214 serves as a stopper surface when the fastening element is swung out, so that it cannot be swung too far, see above, in particular as a stopper surface on the support element 84. A further stopper surface near the stop end 236 serves as a stop on the jigsaw 10 or on the support element 84 when the fastening element 210 is swung back into its initial and/or latched position. The support element 84 has a corresponding positive-locking fit or stopper surface 240.

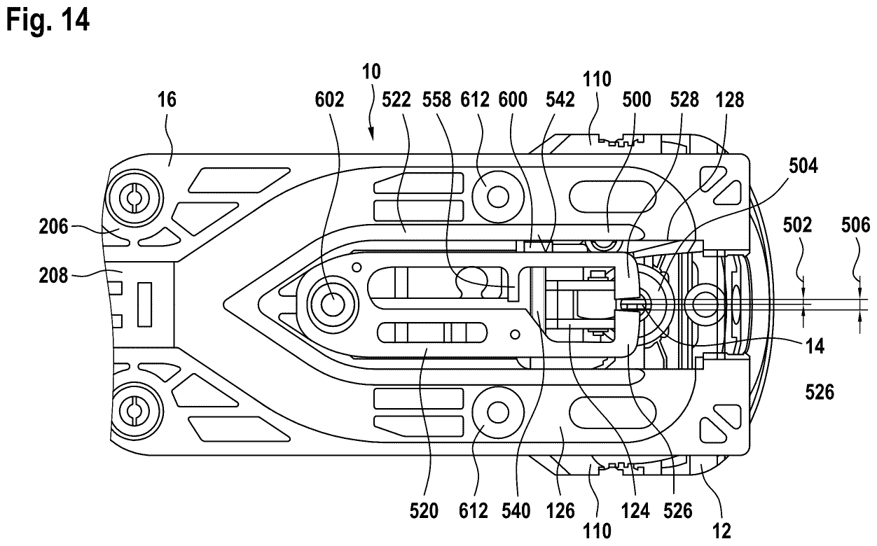

A connection nozzle 228 of the suction nozzle 208, in particular for connection to a vacuum cleaner hose or the like, can be rotated about an axis of rotation 230 of the suction nozzle 208, whereby, for example, suction can take place laterally, that is, to the right or left of the jigsaw 10. The suction nozzle 208 can have support means 232 in order to support itself, for example, relative to a workpiece surface, in particular substantially workpiece contact surfaces 88 with the foot plate 34. A penetration depth of the suction nozzle 208 into the suction nozzle holder 206, or the base plate unit 36, or between the base plate 16 and foot plate 34, is around 10-30%, in particular around 15% of the length l of the base plate 16, in this case around 25 mm. In the region of the suction nozzle holder 206, the base plate unit 36 has a height of a good 10% of the length l of the base plate 16—in this case around 15.5 mm. The suction nozzle holder 206 has an average height of 8.5 mm and an average width of 20 mmm. An air channel 126 for guiding an suction air within the base plate unit 36, in particular between the base plate 16 and that of the foot plate 34, is divided into two air channels (see also FIG. 14). These open into the suction openings 128 at the side of the sawing or chipping region 120 of the jigsaw 10.

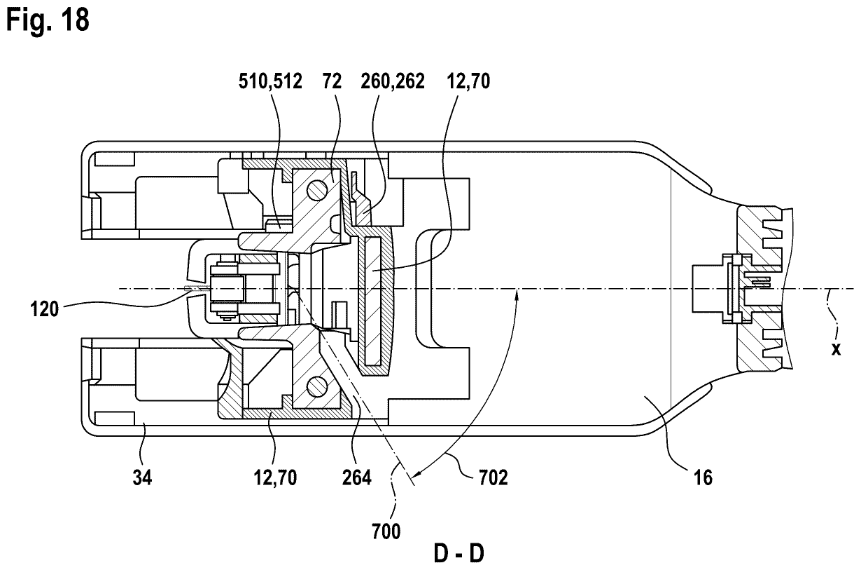

The fastening element 210 is pivotably arranged on the base plate unit 36 and/or the support element 84 for supporting the housing unit 12 of the jigsaw 10 relative to the base plate 16 or the base plate unit 36. The support element 84 is arranged at a distance from the first connecting region 18 between the base plate 16 and the housing unit 12, in particular in the region of the hoist housing 70 or gearbox flange or bearing flange 72. The fastening element is arranged in the oblique or offset region (see FIG. 4) or in the curved region (see FIG. 18) of the support element 84. It is arranged in an oblique or arcuate surface 198, in particular surface 198, in particular between the base plate 16 and the housing unit 12 of the jigsaw 10. It is advantageously arranged flush with the surface 198 of the support element 84, advantageously flush with the surface on the side of the support element 84 facing the housing unit 12. It is advantageously arranged in the concavely or convexly arcuate and/or in the tapering, in particular concavely tapering, region of the support element 84.

The fastening element 210 is pivotably mounted in the recess 212, in particular in the recess 212 of the support element 84. In particular, it is recessed in the base plate unit 36 and/or the support element 84, advantageously flush with the surface 198 of the support element 84 facing the housing unit 12. The base plate unit 36, advantageously the support element 84, surrounds the fastening element 210 in at least one circumferential direction, in particular by 360°, in particular through the recess 212 in the support element 84. Advantageously, the surface 198 of the support element 84 facing the housing unit 12 completely surrounds the fastening element, in particular with the same surface as the fastening element 210.

A pivot bearing 242 of the fastening element 210 is accommodated in a respective support leg 86 of the support element 84, in particular in a support element 84 divided in two by the recess 212 for the fastening element 210. The support legs 86 are formed in mirror-like symmetry to the parting plane 150 of the jigsaw 10 or to the center parting plane of the fastening element 210, that is, the parting plane 150 in which the jigsaw 10 of FIG. 4 is depicted, advantageously a parting plane 150 of the housing shells 152, 154 of the jigsaw 10.

The fastening element 210 is spring-loaded, advantageously pivotably supported against the base plate unit 36, in particular pivotably supported against the support element 84. A stop when pivoting the fastening element 210 in both directions is provided by the base plate unit 36 or the support element 84, in particular by corresponding positive-locking means on the handle element 224 and the support element 84. This advantageously prevents collisions when attaching the suction nozzle 208 to the suction nozzle holder 206.

The fastening element 210 and/or the suction nozzle 208 are designed, in particular having corresponding latching and/or counter-latching means 214, 218, for example by means of guide and/or sliding surfaces, such that the fastening element 210 automatically pivots out of a latching position when the suction nozzle 208 is inserted into the suction nozzle holder 206. In particular, wherein the fastening element 210 swivels back into the latching position when the suction nozzle 208 is fully inserted into the suction nozzle holder 206 in order to form a positive-locking connection with the corresponding latching means 218 on the suction nozzle 208.

A handle element 224 of the fastening element 210 is arranged on a side of the base plate unit 36 or the support element 84 facing the housing unit 12 of the jigsaw 10. This makes it easy to reach via the reach-through opening 22. It can be easily released. The fastening element 210, which is otherwise flush with the surface of the support element 84, is protruded substantially orthogonally by the handle element 224. Advantageously, the fastening element 210 or the handle element 224 is designed to limit pivoting by means of a positive-locking fit between the base plate unit 36 or support element 84 and the fastening element 210 or handle element 224.

The jigsaw 10 thus has a base plate unit 36, a housing unit 12 and a suction unit 204, wherein the suction unit 204 has at least one suction nozzle holder 206, which is designed for detachable connection to a suction nozzle 208, wherein the base plate unit 36 is connected to the housing unit 12 of the jigsaw 10 in a supporting manner via a supporting element 84. It is proposed that the support element 84 has a fastening element 210 for fixing the suction nozzle 208, in particular a movable, advantageously a pivotable, preferably a pivotably mounted fastening element 210, advantageously for a positive-locking fixation of the suction nozzle 208 to, in particular in, the suction nozzle holder 206.

### Pendulum Hoist Adjuster and Blowing Function Adjuster

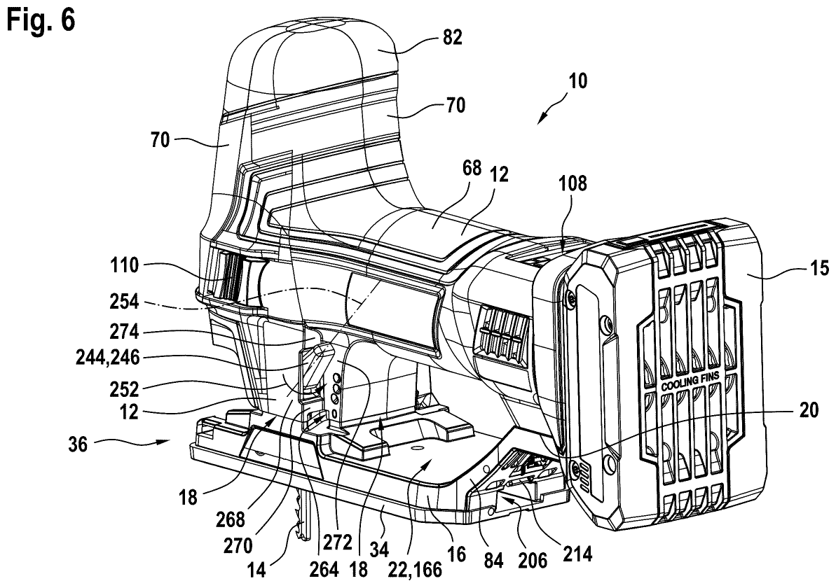

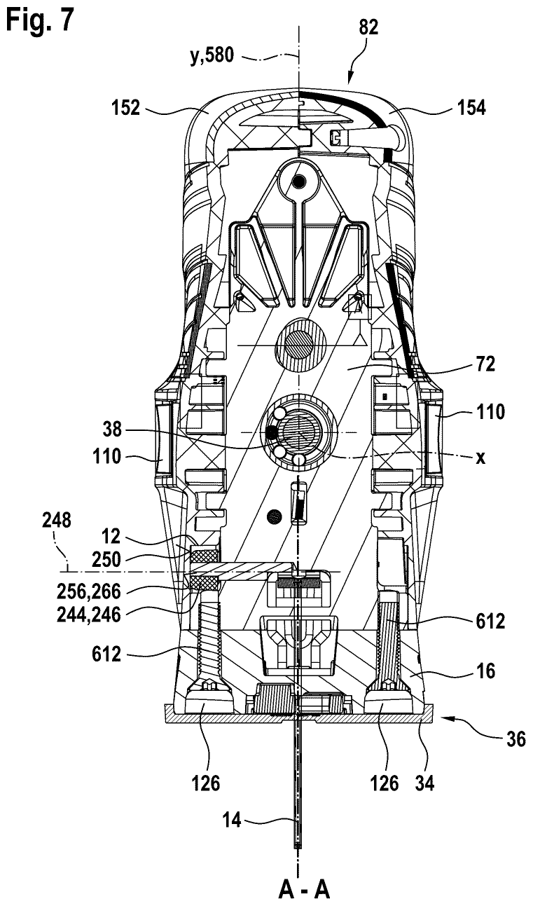

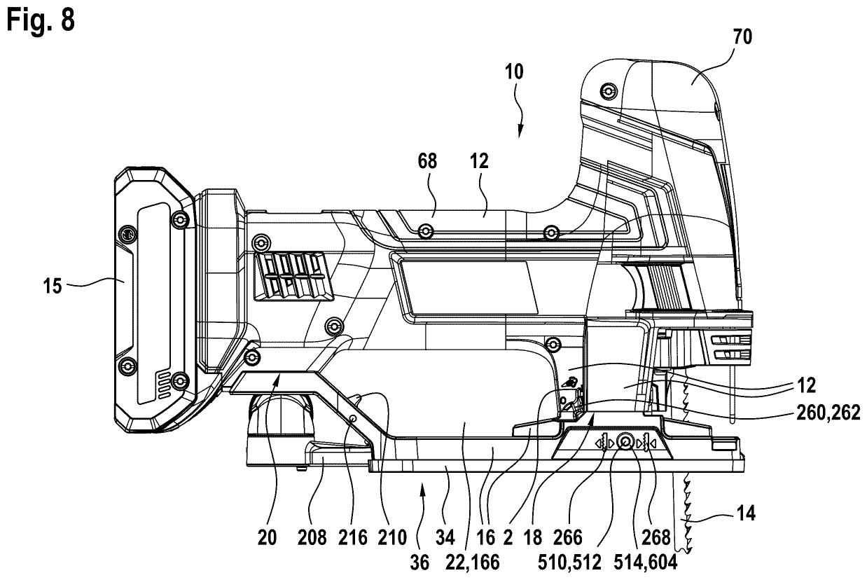

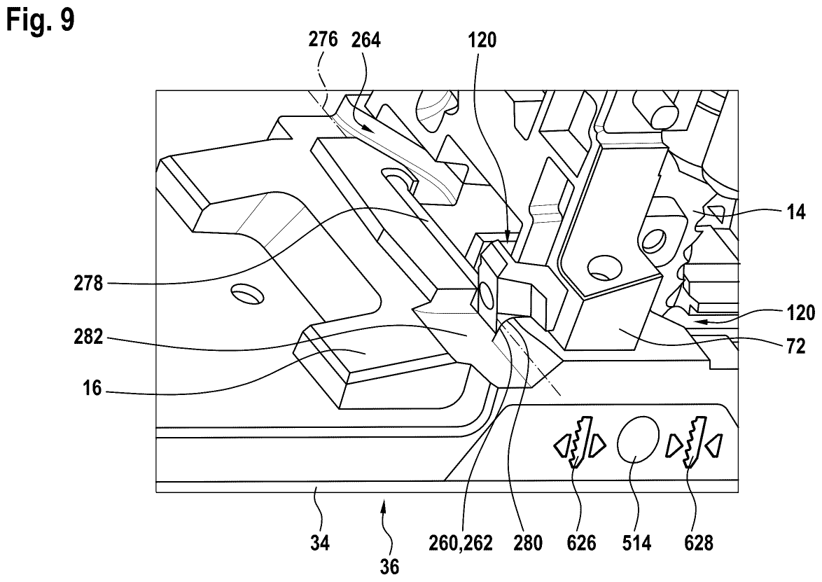

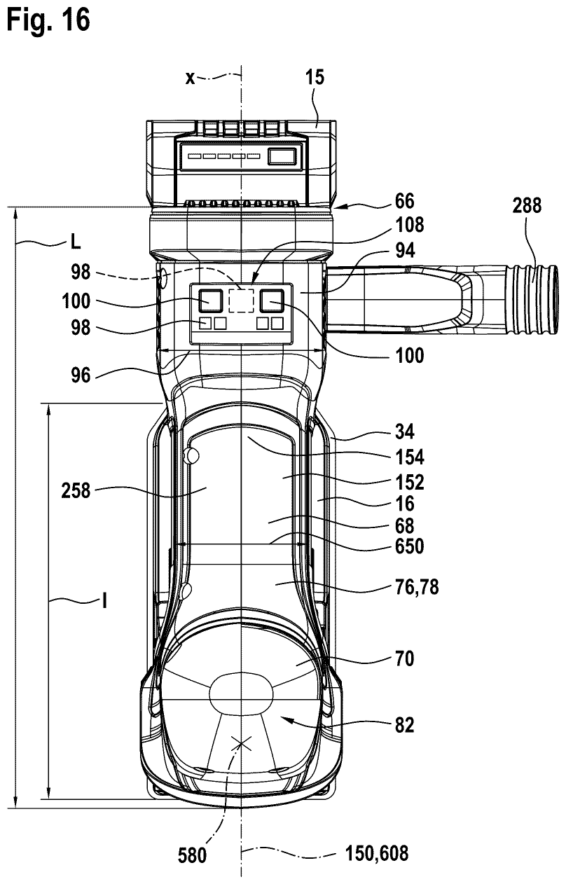

With reference to FIGS. 6 to 9 and 16, a pendulum hoist adjuster and a blowing function adjuster of the jigsaw will be explained below. FIG. 6 shows the jigsaw 10 according to FIG. 1 in a perspective view of a pendulum hoist adjuster, FIG. 7 a section A-A of the jigsaw according to FIG. 1, FIG. 8 a side view of the jigsaw 10 according to FIG. 1 supplemented by a dust nozzle, or a side view of the jigsaw according to FIG. 4, or according to FIG. 16. FIG. 9 shows a perspective magnification view of the blowing function adjuster and finally FIG. 16 a top view of the jigsaw according to FIG. 4.

### Pendulum Hoist Adjuster

The jigsaw 10 as shown in the sectional view of FIG. 7 has a housing unit 12, a base plate unit 36 and a gear frame or bearing flange 72 for a hoist gear 74 and/or a drive train 38 of the jigsaw 10. A pendulum hoist adjuster 244, in particular a pendulum hoist swivel handle 246, is pivotably and swingingly mounted on the gear frame or bearing flange 72. The pendulum hoist adjuster 244 is enclosed axially along its pivot axis 248, on the side 250 facing away from the gear frame or bearing flange 72, by the housing unit 12, in particular axially enclosed. An internal housing wall 266 of the housing unit 12 supports the pendulum hoist adjuster 244 against axial displacement, so to speak. The pendulum hoist swivel handle 246 is enclosed by the housing unit 12 in the circumferential direction 252, in particular about a longitudinal axis 254 of the pendulum hoist swivel handle 246 orthogonal to the swivel axis 248. It is enclosed, so to speak, by the housing regions 268, 270, 272, 274. In particular, it is enclosed through 360° by the housing unit 12, in particular a hoist housing section 70.

The housing unit 12 forms a kind of anti-loss device for the pendulum hoist adjuster 244, in particular an anti-loss device for the pendulum hoist swivel handle 246. It secures the latter against slipping along the swivel axis 248, advantageously without further securing means such as circlips or screws, in particular by the internal housing wall 256 as a stopper surface 266.

It is proposed that the pendulum hoist adjuster 244, in particular the pendulum hoist swivel handle 246 in projection along a hoist axis 580 of the jigsaw 10, is arranged at least substantially, advantageously completely within the projection surface 258 of the housing unit 12. This can in particular be seen in FIG. 16. This forms a top view of the jigsaw 10 in the direction of the hoist axis 580. In other words, the observer looks at the jigsaw 10 from above, perpendicular to the workpiece contact surface 88. The viewer can therefore recognize the projection surface 258 of the housing unit 12. The pendulum hoist adjuster 244 cannot be seen and is thus arranged completely within the projection surface 258 of the housing unit 12. Here, substantially within the projection surface 258 should mean >50%, in particular >75% of the pendulum hoist adjuster 244 within the projection surface 258 of the housing unit 12. This enables sawing close to the wall, for example. In addition, the pendulum hoist adjuster 244, in particular the pendulum hoist swivel handle 246 can be reached when the handle is gripped around, gripping around is not necessary.

The base plate unit 36 is connected to the housing unit 12 and/or to the gear frame or bearing flange 72 in a connecting region 18. At least a part of the pendulum hoist adjuster 244, or the pendulum hoist swivel handle 246, in particular a part arranged within the housing unit 12, comes to lie in projection along the hoist axis 580 of the jigsaw 10, within the projection surface of the connecting region 18. The pendulum hoist adjuster 244 is arranged opposite a workpiece contact surface 88 of the base plate unit 36, in particular directly above a connecting region 18 between the base plate unit 36 and the housing unit 12.

The pendulum hoist adjuster 244 or the pendulum hoist swivel handle 246, in particular a handle end of the pendulum hoist adjuster 244 or the pendulum hoist swivel handle 246, is arranged at least partially in the region of a reach-through opening 22 and/or between two mutually spaced connecting regions 18, 20 of the base plate unit 36 and the housing unit 12.

The pendulum hoist adjuster 244 is arranged relative to a sawing or parting plane 150, 608 of the jigsaw 10 opposite a blowing function adjuster 260, in particular a blowing function adjusting swivel handle 262. The sawing or parting plane 150, 608 is clamped by the hoist axis 580 and the motor axis 28, or longitudinal axis x of the jigsaw 10.

A blow-out opening 264 for blow-off air not directed to the sawing or chipping region 120, in particular blow-off air generated by a fan impeller 160, is arranged in the connecting region 18 between the base plate unit 36 and the housing unit 12. A projection surface of the pendulum hoist adjuster 244 or the pendulum hoist swivel handle 246 and the blow-out opening 264, in projection along the hoist axis 580 of the jigsaw 10, are superimposed.

### Blowing Function Adjuster

In particular according to FIGS. 8 and 9-FIG. 9 is a perspective magnification view in the housing unit 12 is removed—the jigsaw 10 has a blowing function adjuster 260, in particular a blowing function adjusting swivel handle 262. It is provided for selectively setting a blowing function, namely by deflecting motor cooling air either into a sawing or chipping region 120 of the jigsaw 10 or by deflecting it to a blow-out opening 264. The blowing function adjuster 260 is designed to be displaceable, in particular pivotable about a pivot axis 276—here in particular displaceable by around 80°. It is pivotably mounted in the base plate unit 36. In particular, the blowing function adjusting swivel handle 262 is mounted in the base plate unit 36 such that it can be pivoted overhung. A pivot pin 278 accommodates an air guide element 286, or an air guide flap—the air guide element 286 can be seen in FIG. 3, but not FIG. 9, as it is pivoted such that the blow-off air is supplied to the sawing or chipping region 120 (cf. FIG. 3). The pivot pin 278 receives and/or forms the blowing function adjuster 260, in particular the blowing function adjusting swivel handle 262, at one end 280. This/these extends at least partially orthogonally to the pivot axis 276. It protrudes from the housing unit 12 or the base plate unit 36 or base plate 16. In particular, the base plate 16 has a recess 282 so that the blowing function adjuster 260, in particular the blowing function adjusting swivel handle 262, can swivel into the base plate 16 or the recess 282.

The blowing function adjuster 260, or the blowing function adjusting swivel handle 262, is in particular also mounted by the housing unit 12 of the jigsaw 10, in particular a hoist housing section 70, in particular in a connecting region 18 between the base plate unit 36 or the base plate 16 and the housing unit 12. It could sometimes also be mounted between the base plate unit 36 and the gear frame or bearing flange 72.

In particular, FIG. 16 shows that the blowing function adjuster 260, in particular the blowing function adjusting swivel handle 262, is arranged in projection along a hoist axis 580 of the jigsaw 10, at least substantially, advantageously completely, within the projection surface 258 of the housing unit 12. It is therefore not visible here.

It is proposed that the base plate unit 36 is connected to the housing unit 12 and/or to the gear frame or bearing flange 72 in a connecting region 18 and that at least a part of the blowing function adjuster 260, or of the blowing function adjusting swivel handle 262, in particular a part arranged within the housing unit 12, is positioned in projection along a hoist axis 580 of the jigsaw 10 within the projection surface of the connecting region 18. The blowing function adjuster 260, in particular a blowing function adjusting swivel handle 262, comes to rest directly in the connecting region 18 between the base plate unit 36 and the housing unit 12.

The blowing function adjuster 260 or the blowing function adjusting swivel handle 262, in particular a handle end 284 of the blowing function adjuster 260 or the blowing function adjusting swivel handle 262, is arranged at least partially in the region of an opening, 160 or reach-through opening 22 and/or between two mutually spaced connecting regions 18, 20 of the base plate unit 36 and the housing unit 12.

The blowing function adjuster 260 is arranged relative to a sawing or parting plane 150, 608 of the jigsaw 10 opposite a pendulum hoist adjuster 244, in particular a pendulum hoist swivel handle 246. The sawing or parting plane 150, 608 is clamped by the hoist axis 580 and the motor axis 28, or longitudinal axis x of the jigsaw 10.

A blow-out opening 264 for blow-off air not directed to the sawing or chipping region 120, in particular blow-off air generated by a fan impeller 160, is arranged in the connecting region between the base plate unit 36 and the housing unit 12. A projection surface of the pendulum hoist adjuster 244 or the pendulum hoist swivel handle 246 and the blow-out opening 264, are superimposed in projection along a hoist axis 580 of the jigsaw 10. The blow-out opening 264 is arranged relative to a sawing or parting plane 150, 608 of the jigsaw 10 opposite the blowing function adjuster 260, in particular the blowing function adjusting swivel handle 262.

### Pliers Guide Unit

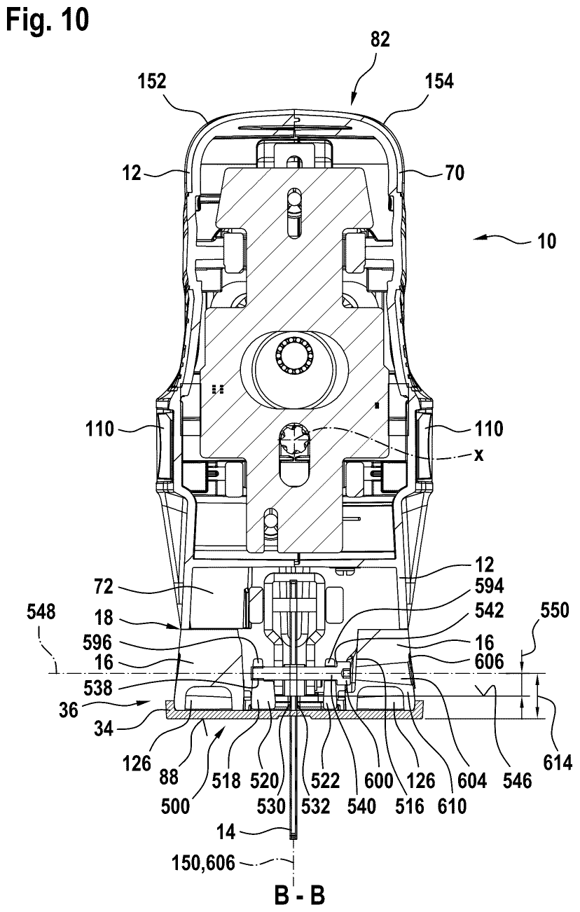

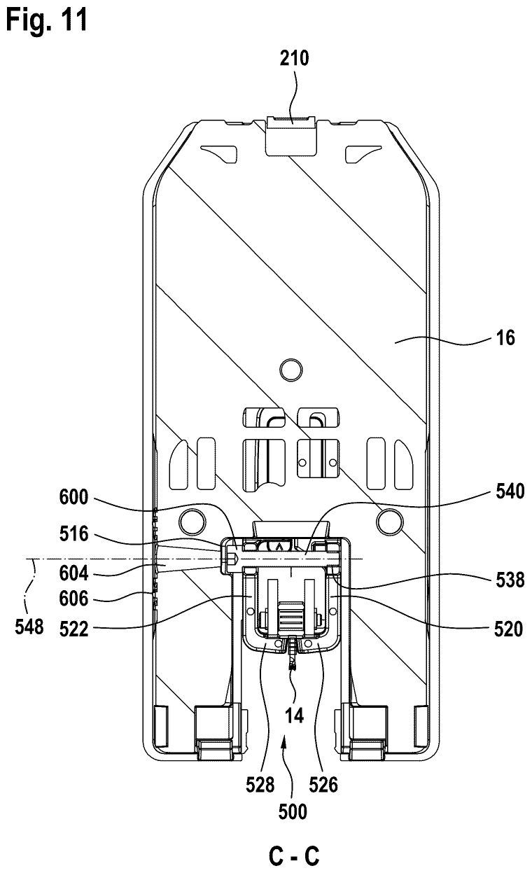

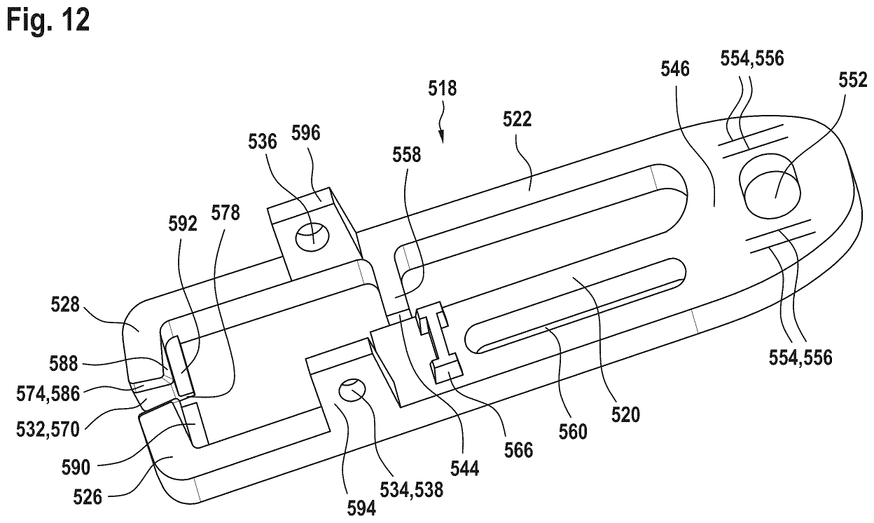

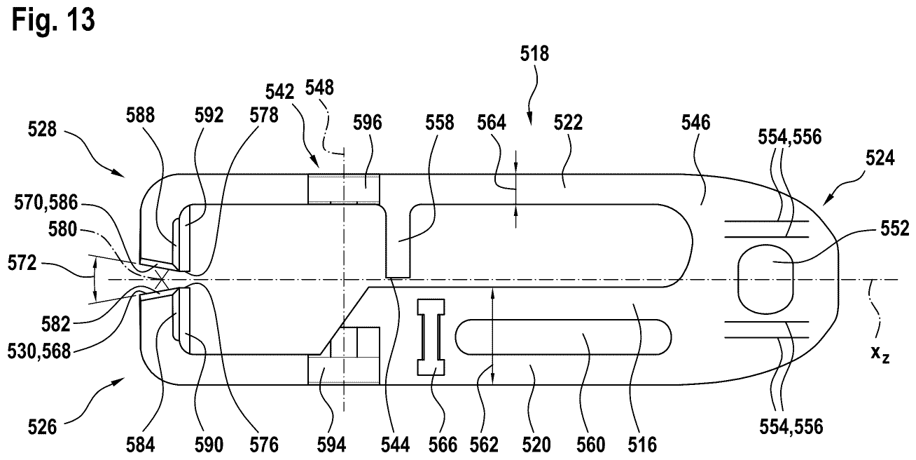

FIGS. 10-14 provide a good explanation of a pliers guide unit 500 of the jigsaw 10 or a pliers guide 518 for the jigsaw 10. FIG. 10 shows the jigsaw 10 according to FIG. 1 in a B-B section, FIG. 11 in a C-C section. FIG. 12 shows the pliers guide 518 in a perspective view, FIG. 13 shows the pliers guide 518 in a plan view. Finally, FIG. 14 shows a section of the jigsaw 10 according to FIG. 4 in a bottom view with the sliding plate or foot plate 34 removed, in particular to show the pliers guide unit 500 or the pliers guide 518 on the jigsaw 10.

FIG. 10 shows the jigsaw 10 having a housing unit 12, a base plate unit 36 and a pliers guide unit 500. The base plate unit 36 comprises at least the base plate 16, here the base plate and foot plate 16, 34. The pliers guide unit 500 is accommodated on the base plate unit 36. It is fixed thereto via the fixing screw 602 (see FIG. 14). The pliers guide unit 500 comprises at least one pliers guide 518 (for details of the pliers guide 518, see also below) and an adjuster 510, in particular an adjusting screw 512. It is provided for adjusting a transverse play 502 of a saw blade 14 that can be inserted into a tool holder 504 of the jigsaw 10. The adjusting means 510 can be used in particular to adjust a distance 506 between guide jaws 530, 532 of the pliers guide unit 500, at least indirectly, for example the clamp holders or adjuster holders 534, 536. The base plate unit 36, in particular the base plate 16, has a tool center opening 514 to enable access to the adjusting means 510 through the base plate unit 36. It is designed as a through hole 604. It protrudes through the base plate 16 or the base plate unit 36. The tool center opening 514 extends from outside the sawing or chipping region 120, and/or one side 606 of the base plate unit 36, through the base plate unit 36 or the base plate 16 to the sawing or chipping region 120 of the base plate unit 36. The tool center opening 514 enables access to the adjuster 510 of the pliers guide unit 500 by means of a tool, in particular by means of a hexagon wrench, advantageously a guided access.

The tool center opening 514 has a longitudinal axis 548 which is formed substantially parallel to the workpiece contact surface 88 of the base plate unit 36 or the base plate or foot plate 16, 34. The longitudinal axis 548 of the tool center opening 514 extends transversely, in particular perpendicular to a parting plane 150 of the jigsaw 10 or a plane of mirror symmetry of the base plate unit 36 or transversely to a sawing plane 608 or sectional plane of the jigsaw 10. The through hole 604 extends the base plate 16, in particular a fork arm 610 of the base plate 16. The through hole has a length of around 10-20 mm, here around 16-17 mm.

The base plate unit 36 forms a loss protection for the adjuster 510, in particular by means of a contact surface 516, in particular a contact surface 516 surrounding the tool center opening 514 for a screw head 600 of the adjusting screw 512. The adjuster 510 or the adjusting screw 512 cannot be removed through the tool center opening 514. A diameter of the screw head 600 is larger than the outlet opening of the tool center opening 514, which means that no additional securing means is required. The design is also very compact.

The tool center opening 514 narrows towards the adjuster 510, in particular it narrows in a frustoconical shape. It narrows towards the parting plane 150. It is surrounded or formed by the base plate 16 and extends from an inlet opening to an outlet opening. In other words, an inlet opening in the base plate to an inner outlet opening towards the setting element 510 or the sawing or chipping region 120. In principle, the tool center opening 514 can also be cylindrical. Due to the narrowing, in particular, the frustoconical embodiment of the tool center opening 514 or the through hole 604, the tool, in this case the hexagon wrench, can be guided exactly to the screw head 600 or the internal hexagon socket opening in the screw head. This means that the tool does not have to be guided exactly into the tool center opening 514. By simply inserting the tool, it is almost automatically guided to the screw head. With a cylindrical or non-constricting design, a guide can still be provided, but not as good a guide for the tool.

The tool center opening 514 extends between an air guide channel 126 of the base plate unit 36 or the base plate 16 and the housing unit 12 of the jigsaw 10. In particular, it extends between an air guide channel 126 of the base plate unit 36 and a connecting region 18 of the base plate unit 36 or base plate 16 to the housing unit 12 and/or to a gearbox flange or bearing flange 72. This first connecting or support region 18 is arranged adjacent to the sawing or chipping region 120, in particular at a distance from a second connecting or support region 20 of the base plate unit 36 and the housing unit 12, advantageously in the rear region 138 of the jigsaw 10. The tool center opening 514 is arranged offset relative to a screw connection 612 between the base plate unit 36 and the sawing or chipping region 120 in the longitudinal axis direction x of the jigsaw 10 with respect to the front side or the front region 130 of the jigsaw 10.

The pliers guide unit 510, in particular the pliers guide 518, advantageously the pliers arms 520, 522 and/or guide jaws 530, 532 of the pliers guide 518, is/are arranged between suction channels 126 of the base plate unit 36 or the base plate surrounding them on both sides, in particular horizontally and/or parallel to the workpiece contact surface 88 surrounding suction channels 126 on both sides.

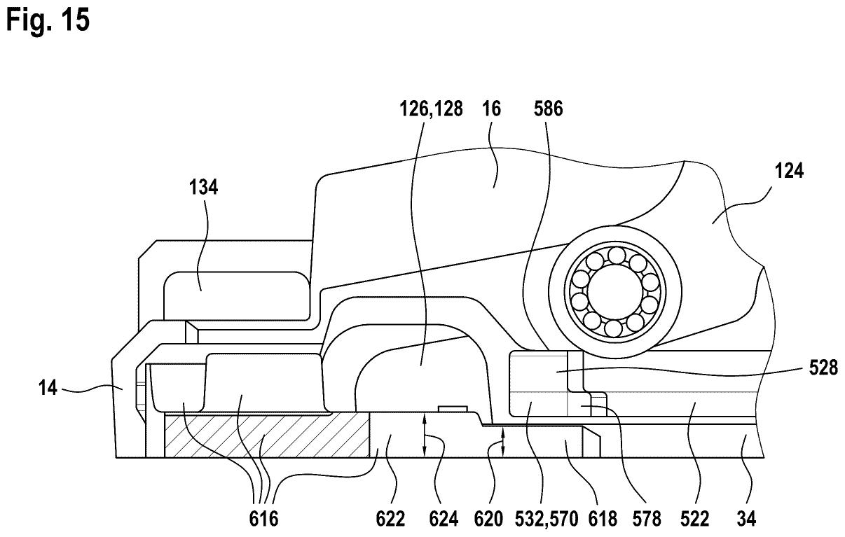

FIG. 15 shows a simplified section of the jigsaw 10 according to FIG. 1 in a sectional view. At least the saw blade 14 is shown to represent a chip breaker guard 616 in connection with the pliers guide unit 500 or the pliers guide 518. The chip breaker guard 616 has a contour that is adapted to the contour of the pliers guide 518. In the longitudinal axis direction x of the jigsaw 10, the chip breaker guard 616 and the pliers guide 518 overlap, in particular in a region of free ends 528 and/or guide jaws 532, in particular in two planes parallel to the workpiece contact surface 88. Advantageously, the pliers guide 518 and/or the chip breaker guard 616 provide one-sided or mutual overload protection, in particular plastic deformation protection, in particular in that they can lie against one another, in particular flat against one another, during load deformation. A distance between pliers guide 518 and chip breaker guard 616, in particular in the hoist axis direction, is advantageously less than 3 mm, in particular around 1 mm, in a rest position.

The chip breaker guard 616 is stepped, in particular stepped in the longitudinal axis direction x. A region 618 overlapping with the pliers guide 518, in particular with a chamfered tip, has a smaller thickness 620 than a region 622 not overlapping with the pliers guide 518, the thickness 624 of which is advantageously 25-100% greater than the thickness 620 of the overlapping region 618.

### Pliers Guide

FIGS. 12 and 13 clearly illustrate the pliers guide 518 for a jigsaw 10. It has a first and a second pliers arm 520, 522. These are connected to each other, in particular are connected to each other in an elastically advantageous manner. They are connected to each other via a yoke 524. At their free ends 526, 528 they have guide jaws 530, 532 facing each other. Pliers arms 520, 522, yoke 524 and guide jaws 530, 532 are formed in one piece. They are formed from metal, advantageously from steel or at least iron. In contrast, the base plate 16 is advantageously made of aluminum. The pliers guide 518 is thus advantageously formed from a stronger material than the base plate 16, as a result of which, for example, positive-locking means 554 or parallel webs 556, as explained further below, can deform plastically when the pliers guide 518 and base plate 16 are connected, in particular with the fixing screw 602. This can counteract slippage of the pliers guide 518 relative to the base plate 16.

The pliers guide 518 has a clamp holder or adjuster holder 534, 536 on each pliers arm 520, 522, in particular for an adjuster 510, in particular a screw 540. The clamp holder or adjuster holder 534, 536 has a thread 538 on the first pliers arm 520 and a screw head contact surface 542 on the second pliers arm. Starting from the pliers arms 520, 522, in particular starting from a contact surface plane 546 of the pliers arms 520, 522 or starting from a base plate contact surface plane of the pliers guide 518, the pliers guide 518 has clamping and adjusting means support arms 594, 596. They extend, so to speak, orthogonally to the pliers arms 520, 522. They have a height that exceeds that of the pliers arms 520, 522, advantageously by a multiple. The clamp holders or adjuster holders 534, 536 are arranged vertically offset from a contact surface 546 of the pliers guide 518 for the base plate unit 36 or the base plate 16. An adjusting center longitudinal axis 548 formed by the clamp holder or adjuster holder 534, 536 has a parallel offset 550 to the contact surface 546 of the pliers guide 518 for the base plate unit 36. This allows the pliers guide to be adjusted by a single adjuster 510. In particular, the pliers guide 518 can thus be positioned close to the workpiece contact surface or close to the workpiece. A saw blade 14 can thus be guided very close to the workpiece. The risk of the saw blade 14 running in a workpiece can at least be reduced during sawing operation of the jigsaw 10.

To fix the pliers guide 518 to the jigsaw 10 or the base plate 16, the pliers guide 518 has a fixing center recess 552, in this case for the fixing screw 602. This is thus designed as a screw hole, preferably as an elongated screw hole, in order to calibrate the pliers guide with regard to the transverse guidance of the saw blade or to adjust it ex works. The elongated hole extends transversely to the longitudinal orientation xz of the pliers guide 518. A contact surface 546 of the pliers guide 518 is provided for frictional contact with the base plate unit 36, wherein the contact surface 546 has the aforementioned positive-locking means 554. The positive-locking means 554 is/are advantageously webs, in particular a plurality of parallel webs 556. They extend essentially parallel to the longitudinal orientation xz of the pliers guide 518 or to the longitudinal orientation of the pliers arms 520, 522. They are in particular in the region of the yoke 524. Advantageously, they surround a fixing center recess 552, in particular on both sides advantageously in mirror-like symmetry on both sides.

The pliers arms 520, 522 are at least partially asymmetrical relative to each other. The end regions 526, 528 of the pliers arms 520, 522 carrying the guide jaws 530, 532 and/or the guide jaws 530, 532 are advantageously formed symmetrically, in particular having mirror-like symmetry to each other, advantageously having mirror-like symmetry substantially to a cutting or sawing plane 150.

The first pliers arm 520 is more rigid than the second pliers arm 522, in particular more rigid in a plane parallel to the workpiece contact surface 88. The first pliers arm 520 is essentially rigid and the second pliers arm 522 is at least more flexible, in particular many times more flexible, for example 5-15 times more flexible. While the second pliers arm is intended to displace by up to 1.5 mm, advantageously 1.2 mm, the first pliers arm 520 meanwhile only displaces by 0-0.3 mm, in particular 01-0.2 mm, i.e. only by a fraction thereof. The second pliers arm 522 is thus intended to be elastically displaced when the adjuster 510 is tightened, in particular towards the first pliers arm 520. When the adjuster 510 is loosened, the second pliers arm 522 bends elastically back to its initial position. The pliers guide 518 is thus provided for asymmetrically displacing the pliers arms 520, 522. This is advantageous because the tool holder 504 advantageously clamps the inserted saw blades 14 on one side against a fixed clamping jaw. The rigid first pliers arm 520 is advantageously arranged on the side of the fixed clamping jaw of the jigsaw 10, in particular with respect to the parting plane 150. When inserting saw blades of different thicknesses, typically 0.8-1.7 mm thick saw blades in jigsaws, in particular 0.9-1.5 mm thick saw blades 14, a distance 506 of the second pliers arm 522 or the guide jaw 532 from the first pliers arm 520 or its guide jaw 530 can be changed accordingly.

The second pliers arm 522 has a cross web 558 transverse to the orientation 522 of the pliers arm, in particular transverse to the orientation of the longitudinal axis xz of the pliers guide 518. The cross web 558 serves as a sling 544, in particular as a bending limiting means, advantageously as overload protection. When tightening the adjuster 510, a user can thus not damage the pliers guide, or at least only damage it with difficulty, in particular not plastically deform it. Since the user cannot directly see a deflection of the pliers guide 518, this is advantageous. The first pliers arm 520 has a counter-stop means for the second pliers arm 522. Advantageously, two symbols 626, 628 for the parallel guide or break shoe guide of the saw blade 14 are arranged on the base plate unit 36 or the base plate 16 (see e.g. FIG. 1). To the right of the tool center opening 514 or the through-hole 604, arrows pointing towards a saw blade, and to the left, arrows pointing away from the saw blade. This allows a user to intuitively recognize that turning the tool, in particular the hexagon wrench or the adjuster 510 to the right reduces the distance 506 and turning it to the left increases the distance 506.

The first pliers arm 520 is designed in sections with two arms, advantageously having an elongated hole 560 extending in the longitudinal axis direction. The first pliers arm 520 has in sections approximately a multiple, advantageously a triple width 562 as the second pliers arm 522, in particular the opposite one, or as its width 564. This makes the second pliers arm more resistant to bending. It can also be built to be lightweight. Its area moment of inertia is increased compared to that of the second pliers arm 522.

The clamp holders or adjuster holders 534, 536 is arranged adjacent to the cross web 558 of the second pliers arm 522 and/or adjacent to the widened region of the first pliers arm 520. It is arranged on a side of the pliers guide 518 facing away from the yoke 524 in the longitudinal axis direction xz and/or facing the guide jaws 530, 532. This arrangement makes it possible to avoid a risk of breakage or a risk of overloading the pliers arms 520, 522. The many times lower flexibility of the first pliers arm 520 is thereby at least influenced, sometimes even made possible. As a result, the clamp holders or adjuster holders 534, 536 are accommodated in a torsion-resistant manner by the pliers arms 520, 522.

The pliers guide 518 has an insertion, insertion means, centering means and/or positive-locking means 566, which in particular projects essentially orthogonally from a contact surface 546 for contact with the base plate unit 36. It is at least partially tapered at an acute angle, in particular tapered at an acute angle towards its free end. Transverse to a longitudinal axis xz of the pliers guide 518, it is advantageously designed to be thicker at opposite ends, in particular thickened in the shape of a dumbbell.

The guide jaws 530, 532 have opposing guide surfaces 568, 570 for a saw blade 14 of the jigsaw 10, in particular for opposing side surfaces of a saw blade 14. The opposing guide surfaces 568, 570 widen in the longitudinal axis direction xz and/or transversely to the longitudinal axis direction xz, in particular at an angle 572, 574 to one another. In particular, they also have guide surfaces 576, 578 that are aligned parallel to one another. In particular, they widen in the longitudinal axis direction xz towards the side facing away from the yoke 524 and/or in the hoist axis direction 580, in particular in the direction of the contact surface 546.

The pliers arms 520, 522 and/or guide jaws 530, 534 have deflection surfaces 582, 584, 586, 588, in particular in the transition region between a contact surface plane 546 and the guide jaws 530, 534. The deflection surfaces extend essentially in and/or transversely to the longitudinal axis xz, in particular along the angled end regions 526, 528 of the pliers arms 520, 522 carrying the guide jaws 530, 534 and/or along the guide jaws 530, 534. They widen advantageously in the hoist axis direction 580, in particular towards a contact surface plane 546, advantageously at an angle. The deflection surfaces 582, 584, 586, 588, which extend in and transversely to the longitudinal axis xz, merge into one another in an advantageously rounded manner. This makes it possible to avoid breakage of the pliers guide 518, in particular of pliers arms 520, 522, when the saw blade 14 runs off and/or when the jigsaw 10 is operated with a damaged or bent saw blade 14, which can also occur suddenly, so to speak, in the middle of operation.

The pliers guide 518 has supporting surfaces 590, 592 which are thinner in the hoist axis direction 580 than the pliers arms 520, 522, in particular projecting in the yoke direction from the angled end regions 526, 528 of the pliers arms 520, 522 carrying the guide jaws 530, 532.

The pliers guide, in particular in conjunction with the adjuster 510 as a so-called pliers guide unit 518, is accommodated on the base plate 16 of the jigsaw 10. To adjust a transverse play 502 of a saw blade 14 inserted into a tool holder 504 of the jigsaw 10, a tool, in particular a hexagon wrench, is inserted into a lateral tool center opening 514 of the base plate and guided through it, in particular through the hollow cone-shaped embodiment of the tool center opening 514 or the through hole 604, to the adjuster 510, in particular the hexagon socket screw head of the adjusting screw 512.

### Functional Interface

FIG. 16 shows a functional interface 108 in a plan view, FIG. 1 and FIG. 2 each in a perspective view. As already mentioned, the jigsaw 10 comprises a housing unit 12 and a base plate unit 36, comprising at least one base plate 16, wherein the housing unit 12 comprises a motor housing 68 whose longitudinal axis x extends substantially parallel to a workpiece contact surface 88 of the base plate unit 36. A functional interface 108, in particular as an HMI, is arranged on an upper side 94 of the motor housing 68 facing away from the workpiece contact surface 88. It is used at least for setting the operating stages of a drive unit 46, in particular an electric motor 24. It is used to output operating parameters. It comprises displays 98 and/or setting buttons 100.

The functional interface 108 is arranged between a battery interface 66 and a handle 76, in particular an advantageously pole-shaped handle 76, 78 of a pole jigsaw 102 according to FIG. 1 surrounding the drive unit 46 or the electric motor 24; or between a battery interface 66 and a bow-shaped handle 106 of a bow jigsaw 104 according to FIG. 2.

The functional interface 108 is arranged in the region of a widening 96 and/or thickening of the motor housing 68, in particular in the rear region 138. This is essentially a square or rectangular widening 96 and/or thickening. Advantageously, the square widening 96 and/or thickening is arranged in an end region 176 of the motor housing section 68 of the jigsaw 10. The motor housing 68 has a greater width 96 in the region of the widening 96 and/or thickening than in the handle region 76, or the region of the motor housing 68 surrounding the drive unit 46, where the motor housing is also substantially round or oval, in particular circular or oval.

The width 96 of the widened and/or thickened region is advantageously 10-50%, in particular around 30%, greater than the width 650 of the handle region 76, or of the region of the motor housing 68 radially surrounding the drive unit 46. The width 96 is around 65 mm, compared to a width 650 of 50 mm. Similarly, the thickness of the motor housing region accommodating the functional interface 108, in particular between the second connecting region 20 and the housing surface surrounding the functional interface 108, so to speak parallel to the hoist axis y, is around 10-50% greater, in particular around 25% greater than the thickness of the handle region 76, or of the region of the motor housing 68 radially surrounding the drive unit 46. Here, the thickness is around 70-75 in the region of the functional interface 108 mm compared with 60 mm in the region of the motor housing 68 radially surrounding the electric motor 24.

The functional interface 108 is arranged relative to a longitudinal axis x of the jigsaw 10, or of the motor housing 68, opposite a second, in particular, connecting region 20 providing support between the housing unit 12 and the base plate unit 36. As already explained, the second connecting region 20 is spaced apart from the first connecting region 18. In particular, an opening 166, in particular a reach-through opening 22, in particular an opening 166 or reach-through opening 22 closed in the parting plane 150, is formed between the motor housing 68, the base plate unit 36 and the connecting regions 18, 20.

The functional interface 108 is recessed into the upper side 94 of the motor housing 68 of the housing unit 12, or the surface thereof. When the jigsaw 10 is placed at least on a flat surface in any position, the functional interface 108 therefore remains free from contact with the flat surface, in particular regardless of whether an exchangeable rechargeable battery pack 15 is attached to the battery interface 66 of the jigsaw 10 or not.

The functional interface 108 is, in particular in the case of a jigsaw 10 designed as a bow jigsaw 104, aligned at an angle to the workpiece contact surface 88 and/or to the longitudinal axis x, in particular at an angle of 10-15°, advantageously around 12.5°—see FIG. 2. In particular, it is inclined towards the front side 136 of the jigsaw 10. The functional interface 108 is accessible via a space formed between the motor housing 68 and the bow handle 106, in particular a handle opening 118. The angled orientation at least improves the accessibility and visibility of the functional interface 108 in a bow jigsaw 104.

FIG. 17 shows an alternative embodiment of a jigsaw 10. It is designed as a pole jigsaw 102, but could also be designed as a bow jigsaw based on FIG. 2. The jigsaw 10 has spaced connecting regions 18, 20 between the base plate 16 and the housing unit 12. The support element 84 is designed to be arcuate—in particular convex when viewed from the reach-through opening 22 or concave when viewed from a workpiece contact surface 88 of a foot plate or sliding plate 34. The motor housing 68 of the housing unit 12 also accommodates an electric motor 24 here. The electric motor 24 drives a saw blade 14 via a hoist gear 74, which converts the rotary movement of the electric motor 24 into a lifting movement of a hoist rod 26 or a output unit 52. An axis of rotation or motor axis 28 of the electric motor 24 is arranged coaxially to the longitudinal axis x of the jigsaw 10. A distance y1 between a workpiece contact surface 88 of a foot plate or sliding plate 34 and the motor axis 28 advantageously falls below 30% of a length L of the jigsaw 10, in particular <25% of the length L of the jigsaw 10 (calculated without battery 15). A distance y1 here is around 75 mm. A pole-shaped handle 78 is delimited by an upper gripping surface 30 and a lower gripping surface 32. The upper gripping surface 30 and the lower gripping surface 32 end at an end of the pole-shaped handle 78 facing the saw blade 14 or in the transition region 92 to the hoist housing 70 essentially in a common plane 90. This extends normal to the longitudinal axis x. A shortest distance between the saw blade 14 and the reach-through opening 22 enclosed by the base plate 16 and the handle 76 falls below a distance x3 of advantageously less than 25% of a length L of the jigsaw (without battery), in particular less than 20%, in this case around 40-50 mm. The jigsaw 10 has an interface 40 or battery interface 66 for the rechargeable battery 15. A shortest distance X2 between the interface 40 for the rechargeable battery 15 and the second connecting region 20 is less than 20%, advantageously 15%, in particular it is around 1-10% of the length L of the jigsaw 10. This has the advantage that if the jigsaw 10 falls, for example onto the floor, for example if the base plate or foot plate 16, 34 strikes first, a force F1 can be introduced as close as possible to the battery 15, or in the rear region of the motor housing 68. If the jigsaw did not have a second connecting region 20 arranged at a distance from the first connecting region 18, in particular with a reach-through opening 22, the force would have to be transmitted via the first or front connecting region 18, which could stress it, in particular due to the high weight and an associated falling force F2 of the battery 15. This would then act on a long “lever arm” of the motor housing 68, so it acts on a short one that supports the force F2, via the connecting region and the counterforce F1. The force F1 is thus transmitted as directly as possible between the housing unit 12 and the base plate 16 in a supporting manner via the second connecting region 20.

FIG. 18 shows a schematic simplified section of the jigsaw 10 normal to the hoist axis y, so to speak in a top view of the base plate. As already explained, a blowing function is provided for selectively supplying blow-off air, advantageously motor cooling air, generated in particular by a fan impeller 160 (see FIG. 3), to a sawing or chipping region 120 of the jigsaw 10 or to a blow-out opening 264 of the jigsaw 10. The blow-out opening 264 is arranged in the connecting region between the base plate unit 36 or base plate 16 and the housing unit 12. In particular, it is arranged in a parting surface, parting joint and/or parting plane between base plate unit 36 and housing unit 12 (cf. here, for example, FIG. 6 or 9). As a result, this is very close to the workpiece contact surface 88.

Both the base plate unit 36 and the housing unit 12, in particular a hoist housing section 70 of the housing unit 12, form part of the blow-out opening 264, in particular a respective notched and/or channel-shaped region. This offers advantages in manufacturing, as both the housing unit 12 or the housing shell 152 and the base plate 16 can be easily manufactured to form the blow-out opening 264 and/or air channels.

Both the base plate unit 36 and the housing unit 12 form at least part of an air guide channel to the blow-out opening 264. Advantageously, they also form at least part of an air guide channel to the sawing or chipping region 120. This can save components and/or installation space.

The blow-out opening 264 is intended to blow out blow-off air laterally and in the direction of a rear region 64 of the jigsaw 10, advantageously at an angle 702 of 30-80°, in particular 50-70°, preferably 60° to a longitudinal axis x of the jigsaw 10, advantageously at an angle of 30-80°, in particular 50-70°, preferably 60° to a cutting or sawing plane 150 of the jigsaw 10 spanned by a hoist axis y and a longitudinal axis x of the jigsaw 10. During sawing, even with inverse cuts, a flow onto the user can be avoided.

A projection surface of a blowing function adjuster 260 or a blowing function adjusting swivel handle and/or a pendulum hoist adjuster 244 or a pendulum hoist swivel handle 246, is superimposed with the blow-out opening 264 in projection along a hoist axis 580 of the jigsaw 10 (cf. in particular FIG. 6 in combination with FIG. 16). The jigsaw can be built compactly despite its extensive functionality.

The blow-out opening 264 is located relative to a sawing or parting plane 150, 608 of the jigsaw 10, which is spanned by a hoist axis y and a longitudinal axis x of the jigsaw 10, opposite a blowing function adjuster 260, in particular blowing function swivel adjuster 262 and/or opposite a pendulum hoist adjuster 244 or of a pendulum hoist swivel handle 246; or it is located on the side of a blowing function adjuster 260, in particular blowing function adjusting swivel handle 262 and/or pendulum hoist adjuster 244 or a pendulum hoist swivel handle 246.

The base plate unit 36 is connected to the housing unit 12 by means of two mutually spaced connecting regions 18, 20, which enclose the opening 166, in particular the reach-through opening 22 (see FIG. 3). The blow-out opening 264 is arranged in the region of and/or adjacent to the region of the opening 166, in particular the reach-through opening 22. This makes it possible to blow out the air at an angle.

A part, in particular a handle end 284, of a blowing function adjuster 260 or a blowing function adjusting swivel handle and/or a pendulum hoist adjuster 244 or a pendulum hoist swivel handle 246, comes to rest at least partially in the region of the opening or reach-through opening 22. This increases comfort. Operation is possible with the same hand even when the handle 76, 78 is gripped. Ergonomics may be improved.

1. A jigsaw, comprising:
a housing unit; and
a base plate,
wherein;
the housing unit is around 40-60% longer than the base plate in a longitudinal direction of the jigsaw, and
the housing unit and the base plate are bracingly interconnected in a rigid or damped manner by two connecting regions mutually spaced in the longitudinal direction of the jigsaw comprising bearing and/or fixing points.

2. The jigsaw according to claim 1, wherein:
the base plate, the housing unit and the mutually spaced connecting regions enclose a reach-through opening; and
a blowing function adjuster and/or a pendulum hoist adjuster and/or a fastening element configured to fix a suction nozzle is arranged at least partially between the two mutually spaced connecting regions and/or in a region of the reach-through opening.

3. The jigsaw according to claim 1, wherein the connecting regions have a distance of 25-75% of the length of the base plate and/or have a distance of 30-50% of the longitudinal extension of the jigsaw.

4. The jigsaw according to claim 2, wherein a center of gravity of the jigsaw, with or without a battery applied to the jigsaw, is positioned within the reach-through opening or between the reach-through opening and the longitudinal axis.

5. The jigsaw according to claim 1, wherein:
a first of the two connecting regions is arranged in a region of a gearbox flange or bearing flange connected to the base plate, or a supporting frame of a hoist gear of the jigsaw; and
a second of the two connecting regions is arranged in a region of a motor housing section of the housing unit of the jigsaw.

6. The jigsaw according to claim 5, wherein the housing unit or a motor housing section in the second of the two connecting regions has a larger circumference around a longitudinal axis compared to a housing region surrounding the drive unit and/or is substantially thickened in square or rectangular form.

7. The jigsaw according to claim 1, wherein:
parting joints of the connecting regions have a vertical offset and/or a horizontal offset relative to each other; and
the vertical offset is around 18 mm, and/or the horizontal offset is around 100 mm.

8. The jigsaw according to claim 1, wherein:
a connecting surface delimited at least by the housing unit in a connecting plane or parting joint plane of a first of the two connecting regions is around 30% of the connecting surface which is delimited by the base plate and/or a foot plate fixed thereto in a workpiece contact plane of the base plate and/or foot plate; and/or
a connecting surface in a connecting plane or parting joint plane of the first of the two connecting regions, which is delimited at least by the housing unit, is around 40% larger than a connecting surface in a connecting plane or parting joint plane of the second connecting region.

9. The jigsaw according to claim 8, wherein:
a connecting surface delimited at least by the housing unit from three sides or substantially U-shaped, in a connecting plane or parting joint plane of a first of the two connecting regions is around 18% of the connecting surface which is delimited by the base plate or a foot plate fixed thereto in a workpiece contact plane and/or
a connecting surface delimited at least by the housing unit (12), in particular a connecting surface delimited by four sides or substantially square or rectangular, in a connecting plane or parting joint plane of the second connecting region is around 13% of the connecting surface which is delimited by the base plate or foot plate in a workpiece contact plane.

10. The jigsaw according to claim 1, wherein;
the housing unit and the base plate are connected via an exposed support element which is exposed in the region of a support leg or support arm having a support end and/or a support surface constituting a second of the two connecting regions to the housing unit; and
the support element is a load-bearing and/or rigid element and/or is formed integrally with the base plate and has or is made of an aluminum alloy.

11. The jigsaw according to claim 10, wherein:
a support leg of the exposed support element forms, in relation to the base plate and/or the housing unit, an offset and/or an oblique shape relative to the longitudinal axis and/or an arcuate shape; and
the support leg forms an angle of around 40-50° with a workpiece contact surface of the base plate and/or foot plate and/or a support surface of the support element for the housing unit.

12. The jigsaw according to claim 10, wherein the exposed support element forms a support surface for the housing unit which is formed parallel to the workpiece contact surface of the base plate and/or foot plate and has an axial and vertical offset with respect to the base plate, and is connected to the base plate by at least one oblique, offset and/or arcuate support leg or support arm.

13. The jigsaw according to claim 10, wherein:
the exposed support element and the housing unit have corresponding positive-locking geometries which provide support in at least two spatial directions extending perpendicularly or obliquely to a longitudinal axis direction and a hoist axis direction of the jigsaw; and
the positive-locking geometries provide support to a battery interface.

14. The jigsaw according to claim 10, wherein the exposed support element is designed such that it tapers concavely from the base plate towards the housing unit so as to have a decreasing width.

15. The jigsaw according to claim 10, wherein:
the exposed support element protrudes axially beyond the base plate on a side of the base plate facing away from the sawing region; and/or
the exposed support element has accommodates a pivotably mounted fastening element configured to fix a suction nozzle via a positive-locking connection.
